(19) United States
(12) Patent Application Publication
(10) Pub. No.: US 2026/0322453 A1
(43) Pub. Date: Oct. 15, 2026

(54) CHANNEL STATE INFORMATION REPORTING

(71) Applicant: QUALCOMM Incorporated, San Diego, CA (US)

(72) Inventors: Qiaoyu LI, Beijing (CN); Tao LUO, San Diego, CA (US); Mahmoud TAHERZADEH BOROUJENI, San Diego, CA (US)

(21) Appl. No.: 19/483,457

(22) PCT Filed: Jul. 12, 2023
(86) PCT No.: PCT/CN2023/106877

§ 371 Date: Nov. 11, 2025

(51) Int. Cl. H04B 7/06; H04B 17/318

(52) U.S. Cl. CPC H04B 7/0626; H04B 17/328

(57) ABSTRACT

Various aspects of the present disclosure generally relate to wireless communication. In some aspects, a user equipment (UE) may identify a priority order for transmitting a channel state information (CSI) report. The UE may selectively transmit the CSI report in accordance with the priority order, the CSI report including a report quantity indicator that indicates one or more predicted channel characteristics, the one or more predicted channel characteristics being predicted by one or more prediction resources associated with the CSI report. Numerous other aspects are described.

### FIELD OF THE DISCLOSURE

Aspects of the present disclosure generally relate to wireless communication and to techniques and apparatuses for channel state information reporting.

### DESCRIPTION OF RELATED ART

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth, transmit power, etc.). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

These multiple access technologies have been adopted in various telecommunication standards to provide a common protocol that enables different UEs to communicate on a municipal, national, regional, or global level. New Radio (NR), which also may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency-division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation.

### SUMMARY

Some aspects described herein relate to a method of wireless communication performed by a user equipment (UE). The method may include identifying a priority order for transmitting a channel state information (CSI) report. The method may include selectively transmitting the CSI report in accordance with the priority order, the CSI report including a report quantity indicator that indicates one or more predicted channel characteristics, the one or more predicted channel characteristics being predicted by one or more prediction resources associated with the CSI report.

Some aspects described herein relate to a method of wireless communication performed by a UE. The method may include identifying a priority order for transmitting a plurality of CSI sub-groups via a CSI report, the plurality of CSI sub-groups being multiplexed on a physical uplink control channel (PUCCH) or a physical uplink shared channel (PUSCH). The method may include selectively transmitting one or more CSI sub-groups of the plurality of CSI sub-groups in accordance with the priority order, the CSI report including a report quantity indicator that indicates a plurality of predicted channel characteristics, the plurality of predicted channel characteristics being predicted by one or more prediction resources associated with the CSI report.

Some aspects described herein relate to a method of wireless communication performed by a network node. The method may include transmitting an indication of a priority order for CSI reporting. The method may include receiving a CSI report in accordance with the priority order, the CSI report including a report quantity indicator that indicates one or more predicted channel characteristics, the one or more predicted channel characteristics being predicted by one or more prediction resources associated with the CSI report.

Some aspects described herein relate to a method of wireless communication performed by a network node. The method may include transmitting a priority order for a plurality of CSI sub-groups included in a CSI report, the plurality of CSI sub-groups being multiplexed on a PUCCH or a PUSCH. The method may include receiving one or more CSI sub-groups of the plurality of CSI sub-groups in accordance with the priority order, the CSI report including a report quantity indicator that indicates a plurality of predicted channel characteristics, the plurality of predicted channel characteristics being predicted by one or more prediction resources associated with the CSI report.

Some aspects described herein relate to a UE for wireless communication. The UE may include one or more memories and one or more processors coupled to the one or more memories. The one or more processors may be configured to identify a priority order for transmitting a CSI report. The one or more processors may be configured to selectively transmit the CSI report in accordance with the priority order, the CSI report including a report quantity indicator that indicates one or more predicted channel characteristics, the one or more predicted channel characteristics being predicted by one or more prediction resources associated with the CSI report.

Some aspects described herein relate to a UE for wireless communication. The UE may include one or more memories and one or more processors coupled to the one or more memories. The one or more processors may be configured to identify a priority order for transmitting a plurality of CSI sub-groups via a CSI report, the plurality of CSI sub-groups being multiplexed on a PUCCH or a PUSCH. The one or more processors may be configured to selectively transmit one or more CSI sub-groups of the plurality of CSI sub-groups in accordance with the priority order, the CSI report including a report quantity indicator that indicates a plurality of predicted channel characteristics, the plurality of predicted channel characteristics being predicted by one or more prediction resources associated with the CSI report.

Some aspects described herein relate to a network node for wireless communication. The network node may include one or more memories and one or more processors coupled to the one or more memories. The one or more processors may be configured to transmit an indication of a priority order for CSI reporting. The one or more processors may be configured to receive a CSI report in accordance with the priority order, the CSI report including a report quantity indicator that indicates one or more predicted channel characteristics, the one or more predicted channel characteristics being predicted by one or more prediction resources associated with the CSI report.

Some aspects described herein relate to a network node for wireless communication. The network node may include one or more memories and one or more processors coupled to the one or more memories. The one or more processors may be configured to transmit a priority order for a plurality of CSI sub-groups included in a CSI report, the plurality of CSI sub-groups being multiplexed on a PUCCH or a PUSCH. The one or more processors may be configured to receive one or more CSI sub-groups of the plurality of CSI sub-groups in accordance with the priority order, the CSI report including a report quantity indicator that indicates a plurality of predicted channel characteristics, the plurality of predicted channel characteristics being predicted by one or more prediction resources associated with the CSI report.

Some aspects described herein relate to a non-transitory computer-readable medium that stores a set of instructions for wireless communication by a UE. The set of instructions, when executed by one or more processors of the UE, may cause the UE to identify a priority order for transmitting a CSI report. The set of instructions, when executed by one or more processors of the UE, may cause the UE to selectively transmit the CSI report in accordance with the priority order, the CSI report including a report quantity indicator that indicates one or more predicted channel characteristics, the one or more predicted channel characteristics being predicted by one or more prediction resources associated with the CSI report.

Some aspects described herein relate to a non-transitory computer-readable medium that stores a set of instructions for wireless communication by a UE. The set of instructions, when executed by one or more processors of the UE, may cause the UE to identify a priority order for transmitting a plurality of CSI sub-groups via a CSI report, the plurality of CSI sub-groups being multiplexed on a PUCCH or a PUSCH. The set of instructions, when executed by one or more processors of the UE, may cause the UE to selectively transmit one or more CSI sub-groups of the plurality of CSI sub-groups in accordance with the priority order, the CSI report including a report quantity indicator that indicates a plurality of predicted channel characteristics, the plurality of predicted channel characteristics being predicted by one or more prediction resources associated with the CSI report.

Some aspects described herein relate to a non-transitory computer-readable medium that stores a set of instructions for wireless communication by a network node. The set of instructions, when executed by one or more processors of the network node, may cause the network node to transmit an indication of a priority order for CSI reporting. The set of instructions, when executed by one or more processors of the network node, may cause the network node to receive a CSI report in accordance with the priority order, the CSI report including a report quantity indicator that indicates one or more predicted channel characteristics, the one or more predicted channel characteristics being predicted by one or more prediction resources associated with the CSI report.

Some aspects described herein relate to a non-transitory computer-readable medium that stores a set of instructions for wireless communication by a network node. The set of instructions, when executed by one or more processors of the network node, may cause the network node to transmit a priority order for a plurality of CSI sub-groups included in a CSI report, the plurality of CSI sub-groups being multiplexed on a PUCCH or a PUSCH. The set of instructions, when executed by one or more processors of the network node, may cause the network node to receive one or more CSI sub-groups of the plurality of CSI sub-groups in accordance with the priority order, the CSI report including a report quantity indicator that indicates a plurality of predicted channel characteristics, the plurality of predicted channel characteristics being predicted by one or more prediction resources associated with the CSI report.

Some aspects described herein relate to an apparatus for wireless communication. The apparatus may include means for identifying a priority order for transmitting a CSI report. The apparatus may include means for selectively transmitting the CSI report in accordance with the priority order, the CSI report including a report quantity indicator that indicates one or more predicted channel characteristics, the one or more predicted channel characteristics being predicted by one or more prediction resources associated with the CSI report.

Some aspects described herein relate to an apparatus for wireless communication. The apparatus may include means for identifying a priority order for transmitting a plurality of CSI sub-groups via a CSI report, the plurality of CSI sub-groups being multiplexed on a PUCCH or a PUSCH. The apparatus may include means for selectively transmitting one or more CSI sub-groups of the plurality of CSI sub-groups in accordance with the priority order, the CSI report including a report quantity indicator that indicates a plurality of predicted channel characteristics, the plurality of predicted channel characteristics being predicted by one or more prediction resources associated with the CSI report.

Some aspects described herein relate to an apparatus for wireless communication. The apparatus may include means for transmitting an indication of a priority order for CSI reporting. The apparatus may include means for receiving a CSI report in accordance with the priority order, the CSI report including a report quantity indicator that indicates one or more predicted channel characteristics, the one or more predicted channel characteristics being predicted by one or more prediction resources associated with the CSI report.

Some aspects described herein relate to an apparatus for wireless communication. The apparatus may include means for transmitting a priority order for a plurality of CSI sub-groups included in a CSI report, the plurality of CSI sub-groups being multiplexed on a PUCCH or a PUSCH. The apparatus may include means for receiving one or more CSI sub-groups of the plurality of CSI sub-groups in accordance with the priority order, the CSI report including a report quantity indicator that indicates a plurality of predicted channel characteristics, the plurality of predicted channel characteristics being predicted by one or more prediction resources associated with the CSI report.

Aspects generally include a method, apparatus, system, computer program product, non-transitory computer-readable medium, user equipment, base station, network entity, network node, wireless communication device, and/or processing system as substantially described herein with reference to and as illustrated by the drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network.

FIG. 2 is a diagram illustrating an example of a network node in communication with a user equipment (UE) in a wireless network.

FIG. 3 is a diagram illustrating an example disaggregated base station architecture, in accordance with the present disclosure.

FIG. 4 is a diagram illustrating examples of channel state information (CSI) reference signal beam management procedures, in accordance with the present disclosure.

FIG. 5 is a diagram illustrating an example of CSI priority rules, in accordance with the present disclosure.

FIG. 6 is a diagram illustrating an example of priority rules for inter-CSI reporting, in accordance with the present disclosure.

FIGS. 7A-7C are diagrams illustrating examples of CSI report priorities for inter-CSI, in accordance with the present disclosure.

FIG. 8 is a diagram illustrating an example of priority rules for intra-CSI reporting, in accordance with the present disclosure.

FIG. 9 is a diagram illustrating an example of CSI report priorities for intra-CSI, in accordance with the present disclosure.

FIG. 10 is a diagram illustrating an example process performed, for example, by a UE, in accordance with the present disclosure.

FIG. 11 is a diagram illustrating an example process performed, for example, by a UE, in accordance with the present disclosure.

FIG. 12 is a diagram illustrating an example process performed, for example, by a network node, in accordance with the present disclosure.

FIG. 13 is a diagram illustrating an example process performed, for example, by a network node, in accordance with the present disclosure.

FIG. 14 is a diagram of an example apparatus for wireless communication, in accordance with the present disclosure.

FIG. 15 is a diagram of an example apparatus for wireless communication, in accordance with the present disclosure.

### DETAILED DESCRIPTION

Channel state information (CSI) may include information associated with a channel between a transmitter and a receiver. The CSI may be reported via a CSI report, such as a CSI report transmitted by a user equipment (UE) to a network node. The CSI may be inter-CSI or intra-CSI. Inter-CSI is CSI that is obtained from different channels. For example, a first network node may obtain CSI associated with a second network node. In contrast, intra-CSI is CSI that is obtained within a single channel, such as between a UE and a network node. Priority rules, such as priority rules for CSI report dropping, may be separately defined for inter-CSI and intra-CSI. In some cases, a UE may transmit beam prediction results, obtained using artificial intelligence (AI) or machine learning (ML) (AI/ML), to a network node via a CSI report. In one example, for spatial beam prediction, the UE may report a predicted Layer 1 (L1) reference signal received power (RSRP), L1 signal-to-interference-plus-noise ratio (SINR), and/or a top quantity of resources (top-K resources) without actually performing measurements, where the prediction results are identified in accordance with one or more measurement resources (such as synchronization signal blocks (SSBs), CSI reference signals (CSI-RSs), and/or demodulation reference signals (DMRSs). In another example, for temporal beam prediction, the UE may report the predicted L1-RSRPs, L1-SINRs, and/or top-K resources for future time occasions, where the prediction results are identified based at least in part on the measurement resources (such as the SSBs, CSI-RSs, and/or DMRSs). However, existing CSI priority rules may not include rules for certain types of CSI reports, such as CSI reports that include measurements that are not actually performed and/or that include measurements for future time occasions. This may result in the CSI report being associated with incorrect priority information. Additionally, or alternatively, this may result in the UE not being able to determine whether to transmit the CSI report or refrain from transmitting the CSI report.

Various aspects generally relate to wireless communications. Some aspects more specifically relate to CSI reporting. In some examples, a UE may identify a priority order for transmitting a CSI report for inter-CSI, and may selectively transmit the CSI report in accordance with the priority order. The UE may identify the priority order in accordance with receiving an indication of the priority order from a network node. The CSI report may include a report quantity indicator that indicates one or more predicted channel characteristics, where the one or more predicted channel characteristics are predicted by one or more prediction resources associated with the CSI report. The UE may identify different priority orders for different types of beam prediction reports, such as general beam prediction reports for L1-RSRP, L1-SINR, and top-K resources, time domain (TD) beam prediction reports for single serving cell scenarios, TD beam prediction reports for multiple serving cell scenarios, beam prediction reports for top-K resources only, and frequency domain (FD) beam prediction reports, among other examples. In some examples, the UE may identify a priority order for transmitting a plurality of CSI sub-groups via a CSI report for intra-CSI, where the plurality of CSI sub-groups are multiplexed on a physical uplink control channel (PUCCH) or a physical uplink shared channel (PUSCH). The UE may selectively transmit one or more CSI sub-groups of the plurality of CSI sub-groups in accordance with the priority order, wherein the CSI report includes a report quantity indicator that indicates a plurality of predicted channel characteristics, the plurality of predicted channel characteristics being predicted by one or more prediction resources associated with the CSI report.

Particular aspects of the subject matter described in this disclosure can be implemented to realize one or more of the following potential advantages. In some examples, by receiving an indication of the priority order from a network node, the described techniques may enable a UE to assign a priority order to a CSI report in accordance with one or more characteristics of the CSI report. In some examples, by identifying the priority order for the CSI report, the described techniques may enable the UE to selectively transmit the CSI report for inter-CSI in accordance with the priority order. For example, the described techniques may enable the UE to determine whether to transmit (or refrain from transmitting) a CSI report that includes general beam predictions, time domain beam predictions for a single serving cell, time domain beam predictions for multiple serving cells, beam predictions for a top quantity of resources, and/or frequency domain beam predictions. In some examples, by identifying a priority order for transmitting a plurality of CSI sub-groups via a CSI report, the described techniques may enable the UE to selectively transmit a CSI report for intra-CSI. These example advantages, among others, are described in more detail below.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

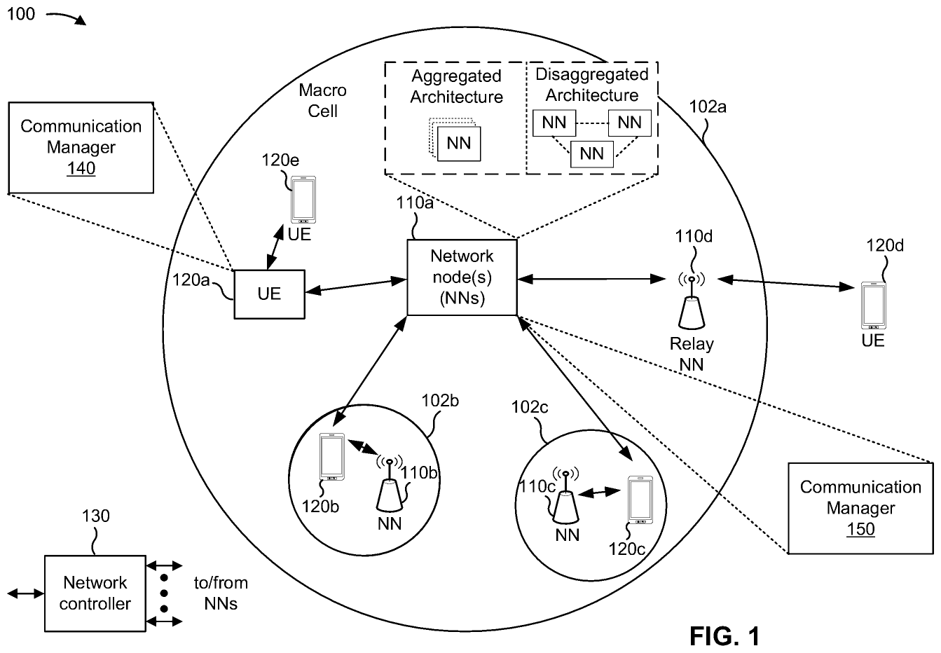

FIG. 1 is a diagram illustrating an example of a wireless network 100. The wireless network 100 may be or may include elements of a 5G (for example, NR) network or a 4G (for example, Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), or other entities. A network node 110 is an example of a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (for example, in 4G), a gNB (for example, in 5G), an access point, or a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 or a network node subsystem serving this coverage area, depending on the context in which the term is used. A network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (for example, three) cells. In some examples, a cell may not necessarily be stationary, and the geographic area of the cell may move according to the location of a network node 110 that is mobile (for example, a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (for example, a network node 110 or a UE 120) and send a transmission of the data to a downstream node (for example, a UE 120 or a network node 110). A relay station may be a UE 120 that can relay transmissions for other UEs 120. In the example shown in FIG. 1, the network node 110d (for example, a relay network node) may communicate with the network node 110a (for example, a macro network node) and the UE 120d in order to facilitate communication between the network node 110a and the UE 120d. A network node 110 that relays communications may be referred to as a relay station, a relay base station, a relay network node, a relay node, or a relay, among other examples.

The wireless network 100 may be a heterogeneous network that includes network nodes 110 of different types, such as macro network nodes, pico network nodes, femto network nodes, or relay network nodes. These different types of network nodes 110 may have different transmit power levels, different coverage areas, or different impacts on interference in the wireless network 100. For example, macro network nodes may have a high transmit power level (for example, 5 to 40 watts) whereas pico network nodes, femto network nodes, and relay network nodes may have lower transmit power levels (for example, 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, a UE function of a network node, or any other suitable device that is configured to communicate via a wireless or wired medium.

Some UEs 120 may be considered machine-type communication (MTC) or evolved or enhanced machine-type communication (eMTC) UEs. An MTC UE or an eMTC UE may include, for example, a robot, an unmanned aerial vehicle, a remote device, a sensor, a meter, a monitor, or a location tag, that may communicate with a network node, another device (for example, a remote device), or some other entity.

Some UEs 120 may be considered Internet-of-Things (IoT) devices, or may be implemented as NB-IOT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any number of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel.

Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120e) may communicate directly using one or more sidelink channels (for example, without using a network node 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the network node 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHZ).

Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHZ), FR4 (52.6 GHz-114.25 GHZ), and FR5 (114.25 GHz-300 GHz). Each of these higher frequency bands falls within the EHF band.

With these examples in mind, unless specifically stated otherwise, the term “sub-6 GHz,” if used herein, may broadly represent frequencies that may be less than 6 GHz, may be within FR1, or may include mid-band frequencies. Further, unless specifically stated otherwise, the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, the UE 120 may include a communication manager 140. In some aspects, as described in more detail elsewhere herein, the communication manager 140 may identify a priority order for transmitting a CSI report; and selectively transmit the CSI report in accordance with the priority order, the CSI report including a report quantity indicator that indicates one or more predicted channel characteristics, the one or more predicted channel characteristics being predicted by one or more prediction resources associated with the CSI report. In some other aspects, as described in more detail elsewhere herein, the communication manager 140 may identify a priority order for transmitting a plurality of CSI sub-groups via a CSI report, the plurality of CSI sub-groups being multiplexed on a PUCCH or a PUSCH; and selectively transmit one or more CSI sub-groups of the plurality of CSI sub-groups in accordance with the priority order, the CSI report including a report quantity indicator that indicates a plurality of predicted channel characteristics, the plurality of predicted channel characteristics being predicted by one or more prediction resources associated with the CSI report. Additionally, or alternatively, the communication manager 140 may perform one or more other operations described herein.

In some aspects, the network node 110 may include a communication manager 150. In some aspects, as described in more detail elsewhere herein, the communication manager 150 may transmit an indication of a priority order for CSI reporting; and receive a CSI report in accordance with the priority order, the CSI report including a report quantity indicator that indicates one or more predicted channel characteristics, the one or more predicted channel characteristics being predicted by one or more prediction resources associated with the CSI report. In some other aspects, as described in more detail elsewhere herein, the communication manager 150 may transmit a priority order for a plurality of CSI sub-groups included in a CSI report, the plurality of CSI sub-groups being multiplexed on a PUCCH or a PUSCH; and receive one or more CSI sub-groups of the plurality of CSI sub-groups in accordance with the priority order, the CSI report including a report quantity indicator that indicates a plurality of predicted channel characteristics, the plurality of predicted channel characteristics being predicted by one or more prediction resources associated with the CSI report. Additionally, or alternatively, the communication manager 150 may perform one or more other operations described herein.

As indicated above, FIG. 1 is provided as an example. Other examples may differ from what is described with regard to FIG. 1.

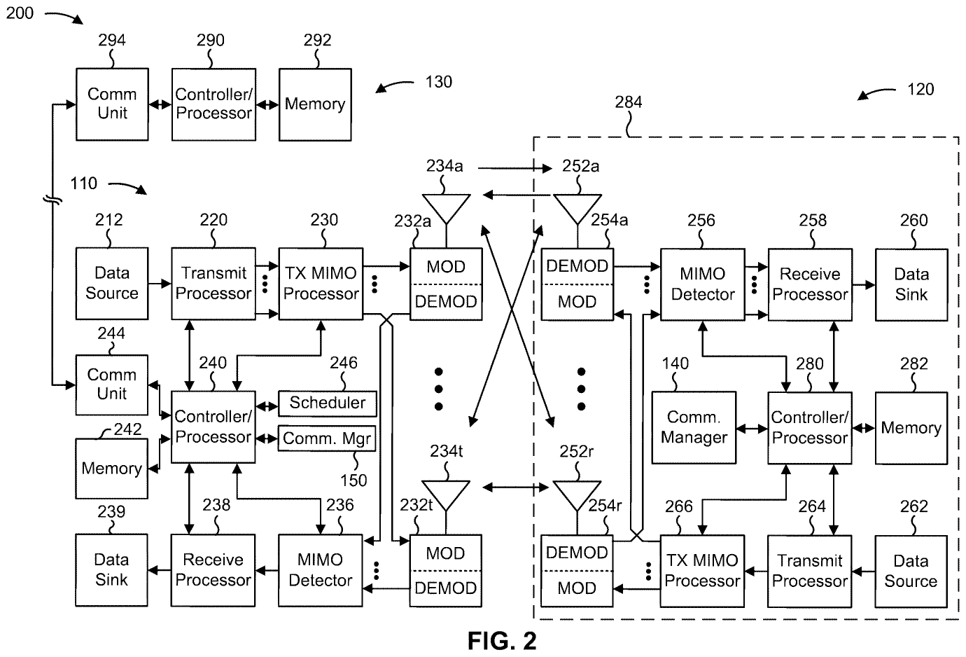

FIG. 2 is a diagram illustrating an example 200 of a network node 110 in communication with a UE 120 in a wireless network 100. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 using one or more channel quality indicators (CQIs) received from that UE 120. The network node 110 may process (for example, encode and modulate) the data for the UE 120 using the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the network node 110 or other network nodes 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine an RSRP parameter, a received signal strength indicator (RSSI) parameter, a reference signal received quality (RSRQ) parameter, or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

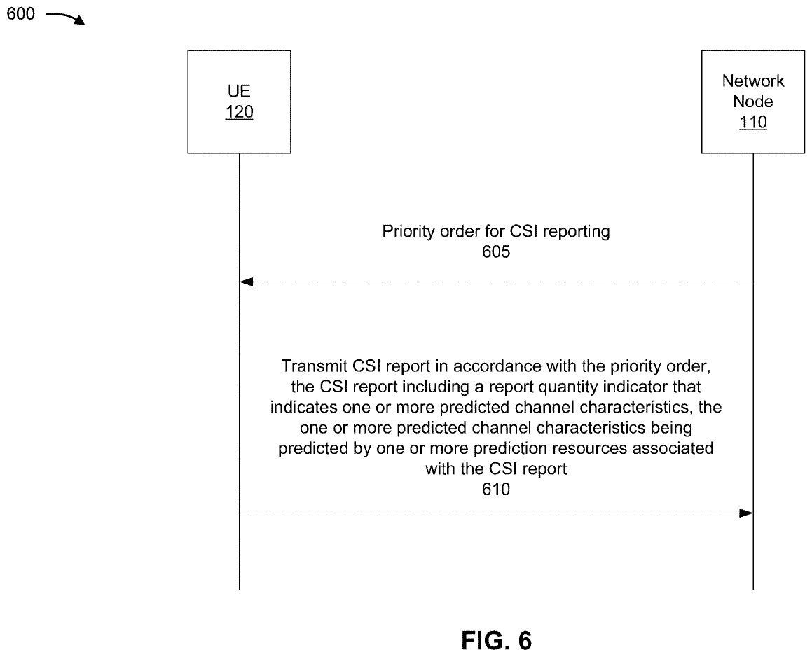

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the processes described herein (e.g., with reference to FIGS. 6-15).

At the network node 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the processes described herein (e.g., with reference to FIGS. 6-15).

In some aspects, the controller/processor 280 may be a component of a processing system. A processing system may generally be a system or a series of machines or components that receives inputs and processes the inputs to produce a set of outputs (which may be passed to other systems or components of, for example, the UE 120). For example, a processing system of the UE 120 may be a system that includes the various other components or subcomponents of the UE 120.

The processing system of the UE 120 may interface with one or more other components of the UE 120, may process information received from one or more other components (such as inputs or signals), or may output information to one or more other components. For example, a chip or modem of the UE 120 may include a processing system, a first interface to receive or obtain information, and a second interface to output, transmit, or provide information. In some examples, the first interface may be an interface between the processing system of the chip or modem and a receiver, such that the UE 120 may receive information or signal inputs, and the information may be passed to the processing system. In some examples, the second interface may be an interface between the processing system of the chip or modem and a transmitter, such that the UE 120 may transmit information output from the chip or modem. A person having ordinary skill in the art will readily recognize that the second interface also may obtain or receive information or signal inputs, and the first interface also may output, transmit, or provide information.

In some aspects, the controller/processor 240 may be a component of a processing system. A processing system may generally be a system or a series of machines or components that receives inputs and processes the inputs to produce a set of outputs (which may be passed to other systems or components of, for example, the network node 110). For example, a processing system of the network node 110 may be a system that includes the various other components or subcomponents of the network node 110.

The processing system of the network node 110 may interface with one or more other components of the network node 110, may process information received from one or more other components (such as inputs or signals), or may output information to one or more other components. For example, a chip or modem of the network node 110 may include a processing system, a first interface to receive or obtain information, and a second interface to output, transmit, or provide information. In some examples, the first interface may be an interface between the processing system of the chip or modem and a receiver, such that the network node 110 may receive information or signal inputs, and the information may be passed to the processing system. In some examples, the second interface may be an interface between the processing system of the chip or modem and a transmitter, such that the network node 110 may transmit information output from the chip or modem. A person having ordinary skill in the art will readily recognize that the second interface also may obtain or receive information or signal inputs, and the first interface also may output, transmit, or provide information.

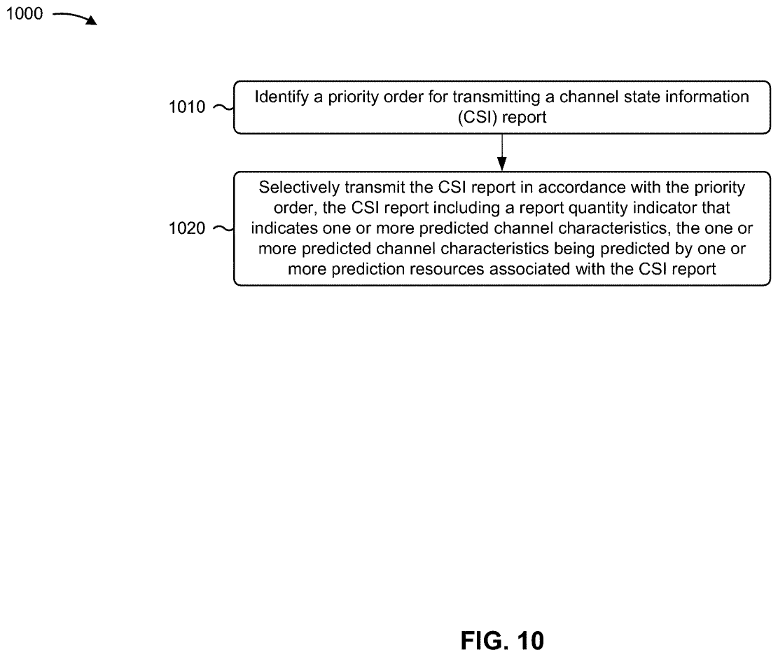

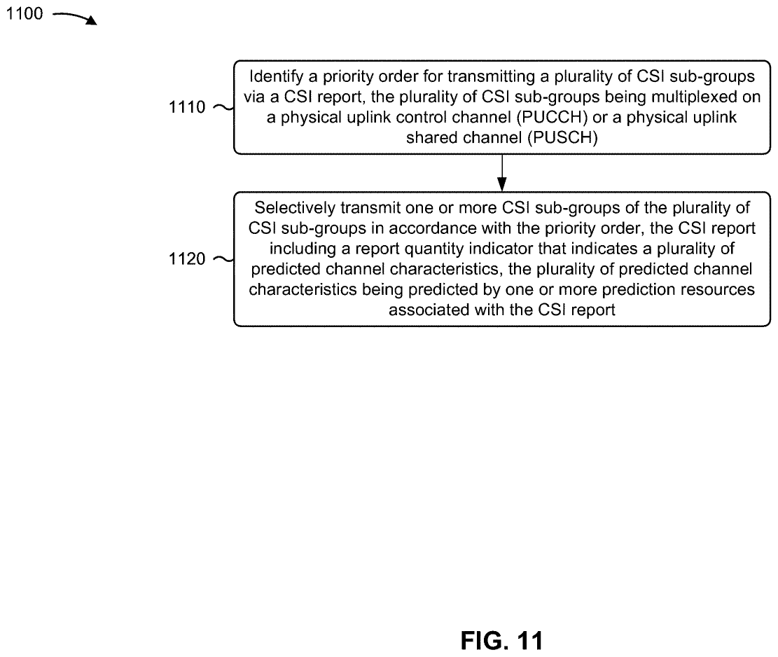

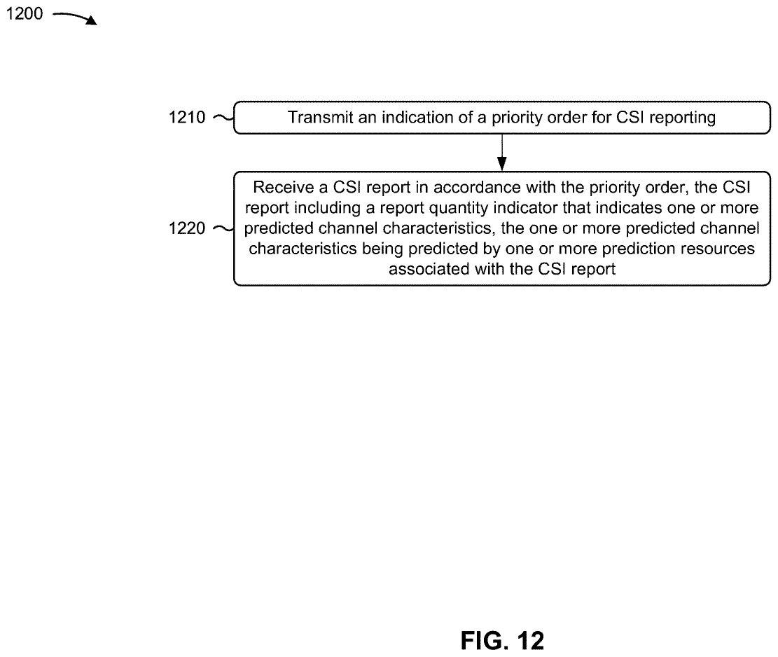

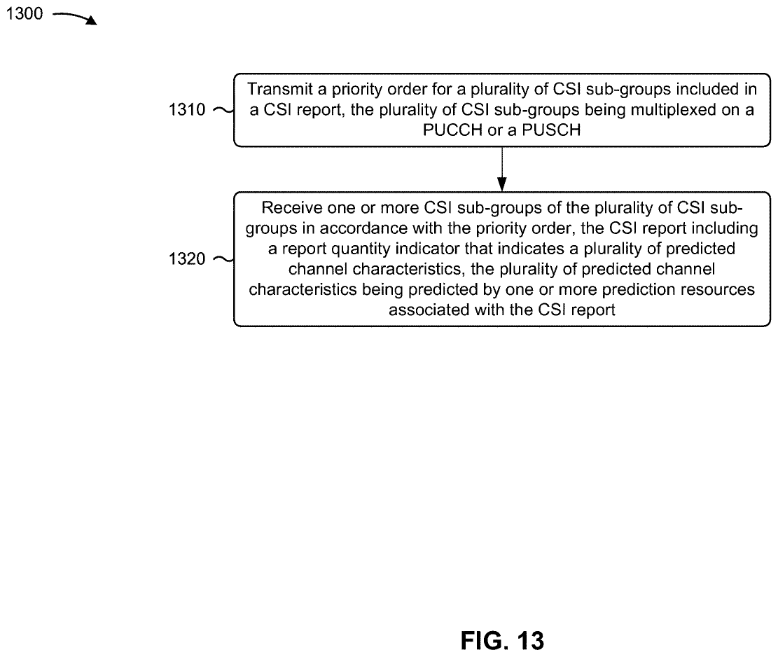

The controller/processor 240 of the network node 110, the controller/processor 280 of the UE 120, or any other component(s) of FIG. 2 may perform one or more techniques associated with CSI reporting, as described in more detail elsewhere herein. For example, the controller/processor 240 of the network node 110, the controller/processor 280 of the UE 120, or any other component(s) (or combinations of components) of FIG. 2 may perform or direct operations of, for example, process 1000 of FIG. 10, process 1100 of FIG. 11, process 1200 of FIG. 12, process 1300 of FIG. 13, and/or other processes as described herein. The memory 242 and the memory 282 may store data and program codes for the network node 110 and the UE 120, respectively.

In some examples, the memory 242 and the memory 282 may include a non-transitory computer-readable medium storing one or more instructions (for example, code or program code) for wireless communication. For example, the one or more instructions, when executed (for example, directly, or after compiling, converting, or interpreting) by one or more processors of the network node 110 or the UE 120, may cause the one or more processors, the UE 120, or the network node 110 to perform or direct operations of, for example, process 1000 of FIG. 10, process 1100 of FIG. 11, process 1200 of FIG. 12, process 1300 of FIG. 13, and/or other processes as described herein. In some examples, executing instructions may include running the instructions, converting the instructions, compiling the instructions, and/or interpreting the instructions, among other examples.

In some aspects, the UE 120 includes means for identifying a priority order for transmitting a CSI report; and/or means for selectively transmitting the CSI report in accordance with the priority order, the CSI report including a report quantity indicator that indicates one or more predicted channel characteristics, the one or more predicted channel characteristics being predicted by one or more prediction resources associated with the CSI report. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the UE 120 includes means for identifying a priority order for transmitting a plurality of CSI sub-groups via a CSI report, the plurality of CSI sub-groups being multiplexed on a PUCCH or a PUSCH; and/or means for selectively transmitting one or more CSI sub-groups of the plurality of CSI sub-groups in accordance with the priority order, the CSI report including a report quantity indicator that indicates a plurality of predicted channel characteristics, the plurality of predicted channel characteristics being predicted by one or more prediction resources associated with the CSI report. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for transmitting an indication of a priority order for CSI reporting; and/or means for receiving a CSI report in accordance with the priority order, the CSI report including a report quantity indicator that indicates one or more predicted channel characteristics, the one or more predicted channel characteristics being predicted by one or more prediction resources associated with the CSI report. The means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, the network node 110 includes means for transmitting a priority order for a plurality of CSI sub-groups included in a CSI report, the plurality of CSI sub-groups being multiplexed on a PUCCH or a PUSCH; and/or means for receiving one or more CSI sub-groups of the plurality of CSI sub-groups in accordance with the priority order, the CSI report including a report quantity indicator that indicates a plurality of predicted channel characteristics, the plurality of predicted channel characteristics being predicted by one or more prediction resources associated with the CSI report. The means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (for example, within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

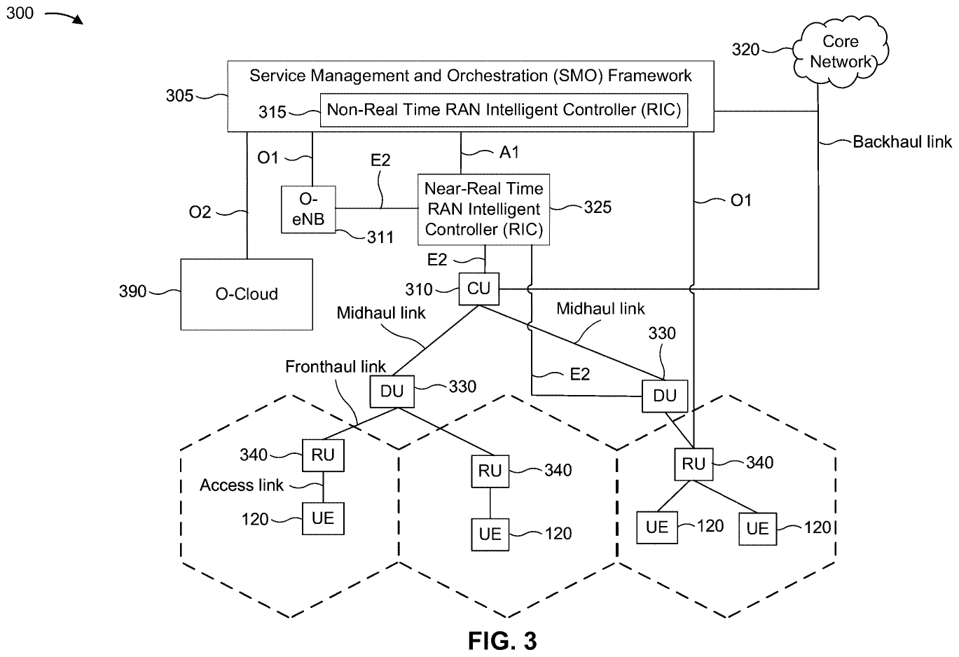

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as a RF transceiver), configured to receive or transmit signals, or both, over a wireless transmission medium to one or more of the other units.

In some aspects, the CU 310 may host one or more higher layer control functions. Such control functions can include RRC functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an Ol interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an Ol interface) or via creation of RAN management policies (such as Al interface policies).

As indicated above, FIG. 3 is provided as an example. Other examples may differ from what is described with regard to FIG. 3.

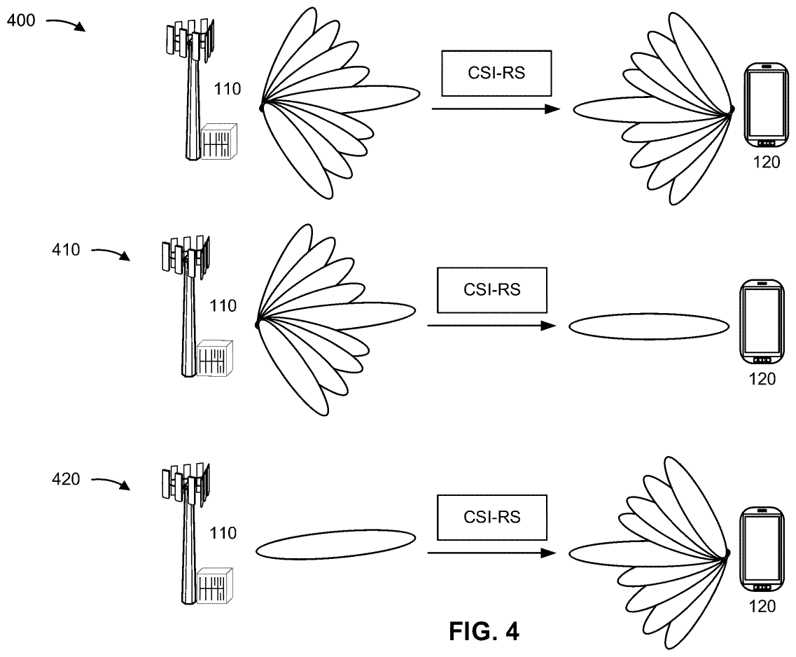

FIG. 4 is a diagram illustrating examples 400, 410, and 420 of CSI-RS beam management procedures, in accordance with the present disclosure. As shown in FIG. 4, examples 400, 410, and 420 include a UE 120 in communication with a network node 110 in a wireless network (e.g., wireless network 100). However, the devices shown in FIG. 4 are provided as examples, and the wireless network may support communication and beam management between other devices (e.g., between a UE 120 and a network node 110 or transmit receive point (TRP), between a mobile termination node and a control node, between an integrated access and backhaul (IAB) child node and an IAB parent node, and/or between a scheduled node and a scheduling node). In some aspects, the UE 120 and the network node 110 may be in a connected state (e.g., an RRC connected state).

As shown in FIG. 4, example 400 may include a network node 110 (e.g., one or more network node devices such as an RU, a DU, and/or a CU, among other examples) and a UE 120 communicating to perform beam management using CSI-RSs. Example 400 depicts a first beam management procedure (e.g., P1 CSI-RS beam management). The first beam management procedure may be referred to as a beam selection procedure, an initial beam acquisition procedure, a beam sweeping procedure, a cell search procedure, and/or a beam search procedure. As shown in FIG. 4 and example 400, CSI-RSs may be configured to be transmitted from the network node 110 to the UE 120. The CSI-RSs may be configured to be periodic (e.g., using RRC signaling), semi-persistent (e.g., using media access control (MAC) control element (MAC-CE) signaling), and/or aperiodic (e.g., using DCI).

The first beam management procedure may include the network node 110 performing beam sweeping over multiple transmit (Tx) beams. The network node 110 may transmit a CSI-RS using each transmit beam for beam management. To enable the UE 120 to perform receive (Rx) beam sweeping, the network node may use a transmit beam to transmit (e.g., with repetitions) each CSI-RS at multiple times within the same RS resource set so that the UE 120 can sweep through receive beams in multiple transmission instances. For example, if the network node 110 has a set of N transmit beams and the UE 120 has a set of M receive beams, the CSI-RS may be transmitted on each of the N transmit beams M times so that the UE 120 may receive M instances of the CSI-RS per transmit beam. In other words, for each transmit beam of the network node 110, the UE 120 may perform beam sweeping through the receive beams of the UE 120. As a result, the first beam management procedure may enable the UE 120 to measure a CSI-RS on different transmit beams using different receive beams to support selection of network node 110 transmit beams/UE 120 receive beam(s) beam pair(s). The UE 120 may report the measurements to the network node 110 to enable the network node 110 to select one or more beam pair(s) for communication between the network node 110 and the UE 120. While example 400 has been described in connection with CSI-RSs, the first beam management process may also use SSBs for beam management in a similar manner as described above.

As shown in FIG. 4, example 410 may include a network node 110 and a UE 120 communicating to perform beam management using CSI-RSs. Example 410 depicts a second beam management procedure (e.g., P2 CSI-RS beam management).

The second beam management procedure may be referred to as a beam refinement procedure, a network node beam refinement procedure, a TRP beam refinement procedure, and/or a transmit beam refinement procedure. As shown in FIG. 4 and example 410, CSI-RSs may be configured to be transmitted from the network node 110 to the UE 120. The CSI-RSs may be configured to be aperiodic (e.g., using DCI). The second beam management procedure may include the network node 110 performing beam sweeping over one or more transmit beams. The one or more transmit beams may be a subset of all transmit beams associated with the network node 110 (e.g., determined based at least in part on measurements reported by the UE 120 in connection with the first beam management procedure). The network node 110 may transmit a CSI-RS using each transmit beam of the one or more transmit beams for beam management. The UE 120 may measure each CSI-RS using a single (e.g., a same) receive beam (e.g., determined based at least in part on measurements performed in connection with the first beam management procedure). The second beam management procedure may enable the network node 110 to select a best transmit beam based at least in part on measurements of the CSI-RSs (e.g., measured by the UE 120 using the single receive beam) reported by the UE 120.

As shown in FIG. 4, example 420 depicts a third beam management procedure (e.g., P3 CSI-RS beam management). The third beam management procedure may be referred to as a beam refinement procedure, a UE beam refinement procedure, and/or a receive beam refinement procedure. As shown in FIG. 4 and example 420, one or more CSI-RSs may be configured to be transmitted from the network node 110 to the UE 120. The CSI-RSs may be configured to be aperiodic (e.g., using DCI). The third beam management process may include the network node 110 transmitting the one or more CSI-RSs using a single transmit beam (e.g., determined based at least in part on measurements reported by the UE 120 in connection with the first beam management procedure and/or the second beam management procedure). To enable the UE 120 to perform receive beam sweeping, the network node may use a transmit beam to transmit (e.g., with repetitions) CSI-RS at multiple times within the same RS resource set so that UE 120 can sweep through one or more receive beams in multiple transmission instances. The one or more receive beams may be a subset of all receive beams associated with the UE 120 (e.g., determined based at least in part on measurements performed in connection with the first beam management procedure and/or the second beam management procedure). The third beam management procedure may enable the network node 110 and/or the UE 120 to select a best receive beam based at least in part on reported measurements received from the UE 120 (e.g., of the CSI-RS of the transmit beam using the one or more receive beams).

As indicated above, FIG. 4 is provided as an example of beam management procedures. Other examples of beam management procedures may differ from what is described with respect to FIG. 4. For example, the UE 120 and the network node 110 may perform the third beam management procedure before performing the second beam management procedure, and/or the UE 120 and the network node 110 may perform a similar beam management procedure to select a UE transmit beam.

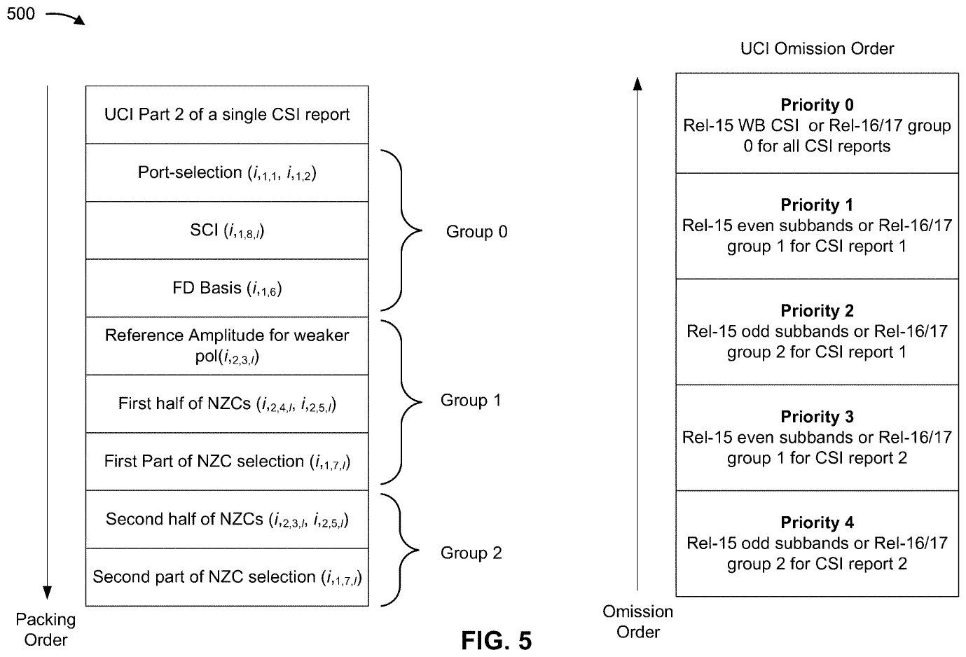

FIG. 5 is a diagram illustrating an example 500 of CSI priority rules, in accordance with the present disclosure. CSI may be inter-CSI or intra-CSI. Inter-CSI is CSI that is obtained from different channels. Priority rules may be defined for inter-CSI and intra-CSI. In one example, inter-CSI priority rules (e.g., as described in 3GPP Technical Specification (TS) 38.214 Section 5.2.5) may be defined as follows, where a smaller value corresponds to a higher priority:
Pri_{iCSI}(y, k, c, s)=2N_{Cells}Mₛy+N_{cells}Mₛk+Mₛc+s, where:
y={0,1,2,3} for {aperiodic (AP) PUSCH (AP-PUSCH), semi-persistent (SP) PUSCH (SP-PUSCH), SP physical uplink control channel (PUCCH) (SP-PUCCH), periodic (P) PUCCH (P-PUCCH)} CSI reports;
k=0 for CSI reports carrying L1-RSRP or L1-SINR and k=1 for CSI reports not carrying L1-RSRP or L1-SINR;
c is the serving cell (ServCell) identifier (ID);
N_{cells} is the value of the radio resource control (RRC) parameter associated with a maximum number of serving cells (maxNrofServingCells);
s is the report configuration ID (reportConfigID) associated with the CSI report setting; and
Mₛ is the RRC parameter associated with the maximum number of CSI report configurations (maxNrofCSI-ReportConfigurations).

In some cases, intra-CSI priority rules (e.g., as described in 3GPP TS 38.214 Section 5.2.2.2) may only be applicable for part-2 CSI multiplexed on a PUxCH (e.g., a PUSCH or a PUCCH), and only certain sub-groups of the part-2 CSI may be omitted, provided that the PUxCH payload does not include the entire Part-2 CSI. In one example, part-2 CSI feedback may be sub-grouped and priority-ordered in accordance with wideband (WB) to subband (SB) (WB-to-SB) orders. As shown in the example 500, intra-CSI may be associated with a “packing order” in accordance with the following (in increasing order): uplink control information (UCI) part-2 of a single CSI report, port-selection, sidelink control information (SCI), frequency domain (FD) basis, reference amplitude for weaker polarization (pol), first half of non-zero crossings (NZC), first part of NZC selection, second half of NZCs, and second part of NZC selection. Additionally, the intra-CSI may be associated with an omission order (in increasing order): priority 4 (includes Release 15 odd subbands or Release 16/17 group 2 for CSI report 2), priority 3 (includes Release 15 even subbands or Release 16/17 group 1 for CSI report 2), priority 2 (includes Release 15 odd subbands or Release 16/17 group 2 for CSI report 1), priority 1 (includes Release 15 even subbands or Release 16/17 group 1 for CSI report 1), and priority 0 (includes Release 15 WB CSI or Release 16/17 group 0 for all CSI reports).

In some cases (e.g., in Release 18+ of the 3GPP Specification), the UE may transmit beam prediction results, such as beam prediction results obtained via AI or ML, to a network node via CSI reports. For example, for spatial beam prediction, the UE may report predicted L1-RSRP, L1-SINR, and/or a top quantity of resources (top-K resources) regarding prediction resources without actually performing measurements, where the prediction results are identified based at least in part on measurement resources (such as SSBs, CSI-RSs, and/or DMRSs). In another example, for temporal beam prediction, the UE may report predicted L1-RSRPs, L1-SINRs, and/or top-K resources with respect to future time occasions, where the prediction results are identified based at least in part on measurement resources (such as the SSBs, CSI-RSs, and/or DMRSs). Existing CSI priority rules may not be applicable for certain types of CSI reports, such as CSI reports where measurements are not actually performed and/or CSI reports that include measurements for future time occasions.

In some cases, inter-CSI priority rules for CSI report dropping may be defined for certain types of CSI reports. For spatial domain (SD) L1-RSRP or L1-SINR predictions, CSI reports carrying predicted L1-RSRPs or L1-SINRs as pure spatial beam prediction results may be interpreted as CSI reports carrying L1-RSRPs or L1-SINRs. For TD L1-RSRP or L1-SINR prediction, priorities may need to be defined. For example, if predicted and reported L1-RSRPs and L1-SINRs are associated with the same serving cell as the current active serving cell of the UE, the priority may be lower (e.g., lower than legacy L1-RSRP and L1-SINR reports or pure spatial domain L1-RSRP and L1-SINR prediction reports). In another example, if the predicted and reported L1-RSRPs and L1-SINRs are associated with a serving cell that is different from the current active serving cell of the UE, such a prediction may be used to prepare for transmission configuration indication (TCI) states to be switched to in neighboring serving cells in lower-layer-triggered-mobility (LTM), where the priority may be as high as legacy L1-RSRP and L1-SINR reports or pure spatial domain L1-RSRP and L1-SINR prediction reports. For top-K prediction without reporting L1-RSRP or L1-SINR (e.g., for CSI reports carrying predicted top-K resources (in terms of predicted L1-RSRP and L1-SINR) but that do not explicitly include the predicted L1-RSRP or L1-SINR values), priorities may need to be defined. In one example, it may be assumed that such reports include the same priority order as that of a CSI report that includes L1-RSRP and L1-SINR values. Additionally, or alternatively, the priority orders may be separately considered if TS beam prediction is considered. For FD beam prediction, if the beam prediction is carried out across different frequency resources (e.g., measuring from sub-6 and reports predicted L1-RSRPs in millimeter wave (mmW)), the priority may be lower than beam prediction associated with the same frequency resource. In addition to inter-CSI priority rules, intra-CSI priority rules for CSI omission may need to be defined for certain types of CSI reports. Particularly, if a beam prediction result includes a flexible payload size, two-part CSI multiplexed on a PUSCH may be considered. For example, the number of beams predicted by the UE may be indicated in CSI Part-1 while the detailed prediction results are reported via CSI Part-2.

As indicated above, FIG. 5 is provided as an example. Other examples may differ from what is described with regard to FIG. 5.

FIG. 6 is a diagram illustrating an example 600 of priority rules for inter-CSI reporting, in accordance with the present disclosure.

As shown by reference number 605, the UE 120 may obtain a priority order for CSI reporting. The priority order for CSI reporting may include one or more priority rules for beam prediction feedback via CSI reports for inter-CSI. The UE 120 may obtain the priority order in accordance with configuration information stored at the UE 120. Additionally, or alternatively, the UE 120 may receive an indication of the priority order from the network node 110. A report quantity indicator (reportQuantity) of the CSI report may include one or more predicted channel characteristics associated with one or more prediction resources, where the one or more prediction resources are associated with (e.g., linked to) the CSI report. In some aspects, the priority order may be used to determine whether the UE 120 is to report the CSI or ignore the CSI at a certain feedback occasion. In some aspects, the prediction resources associated with (e.g., linked with) the CSI report may be based at least in part on SSBs, CSI-RSs, or virtual resources that are not actually transmitted by the network node 110 and/or which are not intended to be measured by the UE 120. In some aspects, the predicted channel characteristics may include at least one of an L1-RSRP, L1-SINR, top-K resources associated with the L1-RSRP, or top-K resources associated with the L1-SINR, among other examples.

The predicted channel characteristics associated with the prediction resources may be identified based at least in part on measurement resources (such as SSBs, CSI-RSs, or DMRSs) that are associated with the CSI report. For SD beam prediction, the predicted channel characteristics may be associated with a same TD occasion that is used by the UE to perform measurements associated with the measurement resources, where the prediction resources and measurement resources include (fully or partially) non-overlapping transmission spatial filters. For TD beam prediction, the predicted channel characteristics may be associated with a TD occasion that is later than the TD occasion that is used by the UE to perform measurements associated with the measurement resources, or that is later than a TD occasion that is used by the UE for transmitting the CSI report to the network node. For FD beam prediction, the prediction resources and measurement resources may be associated with different frequency spectrums (e.g., different frequency ranges, frequency bands, or component carriers, among other examples).

In a first example, the UE 120 may obtain or identify one or more priority rules for a general beam prediction report that includes predicted L1-RSRP, L1-SINR, or top-K resource measurements. For a CSI report that includes pure beam prediction results (e.g., for SD, TD, and FD beam prediction), where the report quantity includes at least one of the predicted L1-RSRP, L1-SINR, or top-K resources, the UE 120 may use the same priority order as that of legacy CSI reports whose report quantity includes (measured) L1-RSRPs or L1-SINRs. In one example, k=0 for CSI reports carrying L1-RSRP, L1-SINR, or predicted top-K prediction resources (in terms of either predicted L1-RSRP or L1-SINR) and k=1 for CSI reports not carrying L1-RSRP, L1-SINR, or predicted top-K prediction resources (in terms of either predicted L1-RSRP or L1-SINR), where the L1-RSRP or L1-SINR is associated with a measurement of the measurement resources or is associated with a prediction of the prediction resources associated with the same time occasions where the UE 120 measures the measurement resources associated with the CSI report.

In a second example, the UE 120 may obtain or identify one or more priority rules for a TD beam prediction report that includes predicted L1-RSRP, L1-SINR, or top-K resources for a single serving cell scenario. For a CSI report that includes TD beam prediction results, where the report quantity includes at least predicted L1-RSRP, L1-SINR, or top-K resources, the UE 120 may identify a priority order that is lower than a legacy L1-RSRP or L1-SINR CSI report and/or a CSI report that includes predicted L1-RSRP, L1-SINR, and top-K resources not associated with future occasions (e.g., non-TD prediction), but that is higher than other CSI reports that do not include measured or predicted L1-RSRP and L1-SINR. In some aspects, the priority order may be further dependent on the CSI reports in comparison being of the same type (e.g., in terms of P, SP, or AP and/or in terms of PUSCH or PUCCH). In one example, k=0.5 for CSI reports carrying predicted L1-RSRP or L1-SINR or predicted top-K prediction resources (in terms of either predicted L1-RSRP or L1-SINR), where the L1-RSRP, L1-SINR, or top-K prediction resources are associated with time occasions that are later than a time occasion during which the UE 120 measures the measurement resources associated with the CSI report, or that are later than a time occasion during which the UE 120 reports the prediction results.

In a third example, the UE 120 may obtain or identify one or more priority rules for a TD beam prediction report that includes predicted L1-RSRP, L1-SINR, or top-K resources for a multiple serving cell (e.g., cross-serving-cell) scenario. For a CSI report that includes TD beam prediction results, where the report quantity includes at least predicted L1-RSRP, L1-SINR, or top-K resources, the UE 120 may identify a priority order associated with the CSI report in accordance with an indication received from the network node 110 (e.g., via an RRC message, a MAC control element (MAC-CE), or downlink control information (DCI)). In some aspects, the priority order may be further dependent on the prediction resources associated with the prediction results being defined within serving cells that are different from the currently active serving cell for the UE 120. Due to non-ideal backhaul, prediction of future TCI states may be needed, and a priority of the predictions may be in accordance with an SD beam prediction within the serving cell. Additionally, or alternatively, a non-ideal backhaul may or may not be presented, depending on network implementations (and thus, network node control of the CSI report priority may be preferred). In one example, the network node 110 may indicate the value of k (e.g., between 0 and 1) via RRC, MAC-CE, or DCI for CSI reports carrying predicted L1-RSRP or L1-SINR or predicted top-K prediction resources (e.g., in terms of either predicted L1-RSRP or L1-SINR), where the L1-RSRP, L1-SINR, and top-K prediction resources are associated with time occasions that are later than a time occasion during which the UE 120 measures the measurement resources associated with the CSI report, or that are later than a time occasion during which the UE 120 reports the prediction results. When the value of k is transmitted via RRC, the value of k may be configured by the associated CSI report setting. When the value of k is transmitted via MAC-CE, the value of k may be indicated by the MAC-CE activating the (SP) CSI report. When the value of k is transmitted via DCI, the value of k may be RRC configured by the CSI-AssociatedReportConfigInfo of the (AP) CSI report and may be triggered by the DCI.

In a fourth example, the UE 120 may obtain or identify one or more priority rules for a beam prediction report that includes only top-K resources. For a CSI report that includes SD, TD, or FD beam prediction results, where the report quantity includes at least predicted top-K resources (e.g., in terms of L1-RSRP or L1-SINR), the UE 120 may identify a priority order associated with the CSI report in accordance with an indication received from the network node 110 (e.g., via RRC, MAC-CE, or DCI). In accordance with the network node 110 relying on the top-K predictions at the UE 120 to determine the DL TCI states, the priority of the CSI report may be higher (e.g., in the case of pure SD prediction). However, in accordance with the network node 110 only relying on the top-K predictions to schedule non-zero power (NZP) CSI-RSs for the UE 120 to use for carrying out actual measurements, the priority of the CSI report may be lower. In this case, enabling network node controllable priority orders for such CSI reports may be beneficial. In one example, the network node 110 may indicate the value of k (e.g., between 0 and 1) via RRC, MAC-CE, or DCI for CSI reports carrying predicted top-K prediction resources (e.g., in terms of either predicted L1-RSRP or L1-SINR). When the value of k is transmitted via RRC, the value of k may be configured by the associated CSI report setting. When the value of k is transmitted via MAC-CE, the value of k may be indicated by the MAC-CE activating the (SP) CSI report. When the value of k is transmitted via DCI, the value of k may be RRC configured by the CSI-AssociatedReportConfigInfo of the (AP) CSI report and may be triggered by the DCI.

In a fifth example, the UE 120 may obtain or identify one or more priority rules for an FD beam prediction report. For a CSI report that includes TD beam prediction results, where the report quantity includes at least predicted L1-RSRP, L1-SINR, or top-K resources, the UE 120 may identify a priority order associated with the CSI report in accordance with an indication received from the network node 110 (e.g., via RRC, MAC-CE, or DCI). The priority order for the CSI report may be further dependent on the prediction resources associated with the CSI report being defined within a frequency spectrum (e.g., frequency range, frequency band, or component carrier) that is different from the frequency spectrum that is defined for the measurement resources associated with the CSI report. Generally, FD beam prediction may be coarse (e.g., as compared to SD and TD beam prediction), and a priority for FD beam prediction may be lower than a priority for SD and TD beam prediction.

However, in an example where the network node 110 is not to spend UE-specific overhead to complete beam management in mmW communications, the FD beam prediction priority may be higher. In this case, enabling network node controllable priority orders for such CSI reports may be beneficial. In one example, the network node 110 may indicate the value of k (e.g., varied between 0 and 1) via RRC, MAC-CE, or DCI for CSI reports carrying predicted L1-RSRP or L1-SINR or predicted top-K prediction resources (e.g., in terms of either predicted L1-RSRP or L1-SINR), where the prediction resources and measurement resources associated with the CSI report are defined in different frequency ranges, frequency bands, or component carriers. When the value of k is transmitted via RRC, the value of k may be configured by the associated CSI report setting. When the value of k is transmitted via MAC-CE, the value of k may be indicated by the MAC-CE activating the (SP) CSI report. When the value of k is transmitted via DCI, the value of k may be RRC configured by the CSI-AssociatedReportConfigInfo of the (AP) CSI report and may be triggered by the DCI.

As shown by reference number 610, the UE 120 may selectively transmit the CSI report in accordance with the priority order. For example, the UE 120 may transmit, and the network node 110 may receive, the CSI report in accordance with the priority order. In one example, the UE 120 may transmit a first CSI report and may drop (e.g., refrain from transmitting) a second CSI report in accordance with the first CSI report having a higher priority than the second CSI report. In another example, the UE 120 may transmit a first CSI report prior to transmitting a second CSI report in accordance with the first CSI report having a higher priority than the second CSI report.

As indicated above, FIG. 6 is provided as an example. Other examples may differ from what is described with regard to FIG. 6.

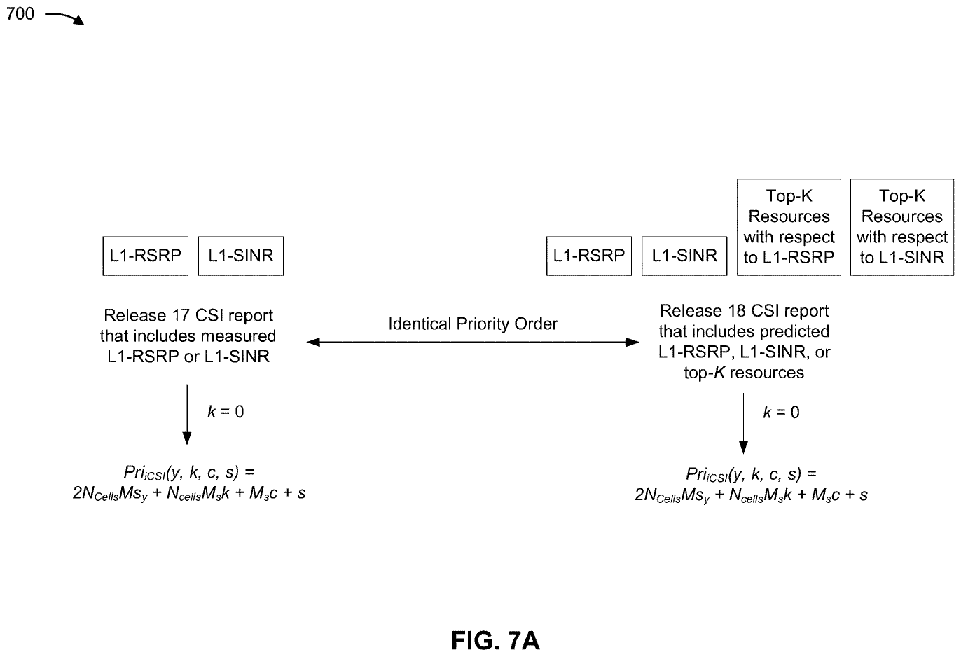

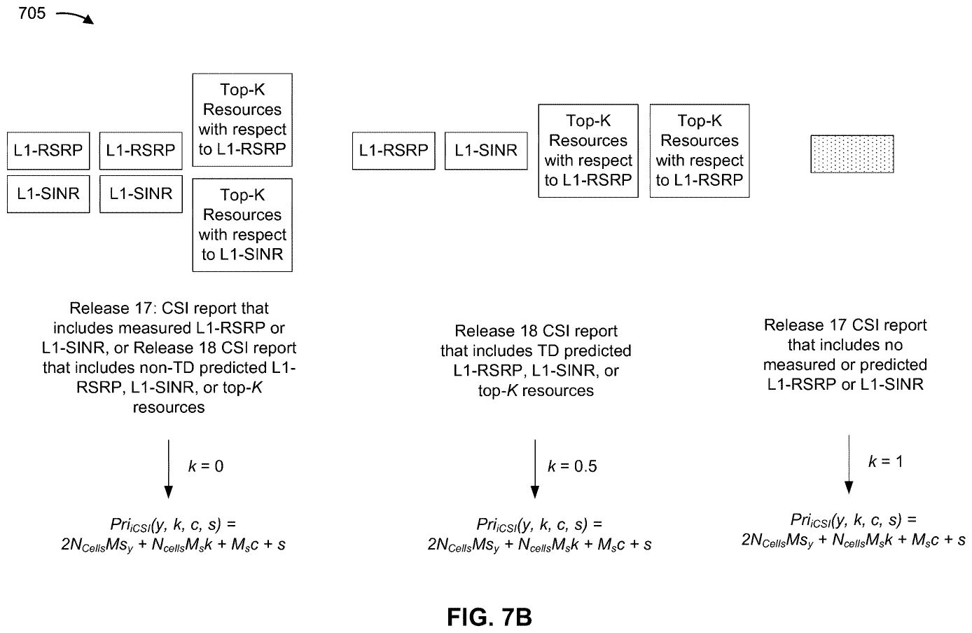

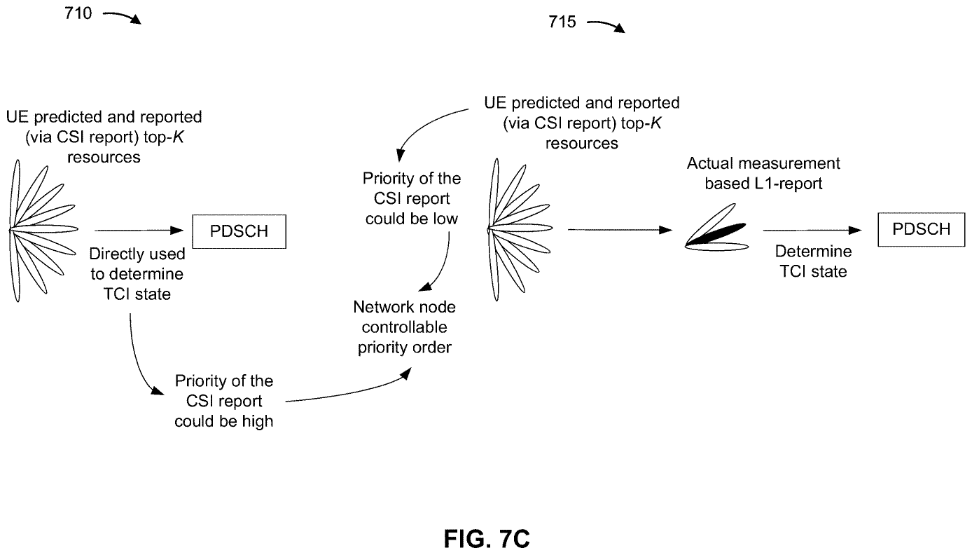

FIGS. 7A-7C are diagrams illustrating examples of CSI report priorities for inter-CSI, in accordance with the present disclosure.

As shown in FIG. 7A and example 700, a Release 17 CSI report that includes measured L1-RSRP or L1-SINR measurements may have an identical priority order as a Release 18 CSI report that includes predicted L1-RSRP, L1-SINR, or top-K resources. For example, the Release 17 CSI report that includes the measured L1-RSRP or L1-SINR may have a priority of k=0, and the Release 18 CSI report that includes the predicted L 1-RSRP, L 1-SINR, or top-K resources may also have a priority of k=0. Additional details regarding these features are described above in connection with the first example described in connection with reference number 605 of FIG. 6.

As shown in FIG. 7B and example 705, a Release 17 CSI report that includes measured L1-RSRP or L1-SINR measurements or that includes non-TD predicted L1-RSRP, L1-SINR, or top-K resources may have a priority that is lower than a Release 18 CSI report that includes TD-predicted L1-RSRP, L1-SINR, or top-K resources.

However, the Release 18 CSI report that includes the TD-predicted L1-RSRP, L1-SINR, or top-K resources may have a priority that is lower than another Release 17 CSI report that includes no measured or predicted L1-RSRP or L1-SINR. For example, the Release 17 CSI report that includes the measured L1-RSRP or L1-SINR measurements or the non-TD predicted L1-RSRP, L1-SINR, or top-K resources may have a priority of k=0, the Release 18 CSI report that includes the TD-predicted L1-RSRP, L1-SINR, or top-K resources may have a priority of k=0.5, and the Release 17 CSI report that includes no measured or predicted L1-RSRP or L1-SINR may have a priority of k=1. Additional details regarding these features are described above in connection with the second example described in connection with reference number 605 of FIG. 6.

As shown in FIG. 7C and example 710, UE-predicted and reported top-K resources may be reported via a CSI report using a PDSCH. The UE-predicted and reported top-K resources may be used (directly) to determine a TCI state. In an example where the priority of the CSI report is high, a network node controllable priority order may be used. As shown in example 715, the UE-predicted and reported (via CSI report) top-K resources may be used to obtain an actual measurement-based L1-report, and the measurement-based L1-report may be transmitted using a PDSCH. In this case, the measurement-based L1-report may be used to determine the TCI state. In an example where the priority of the CSI report is low, a network node controllable priority order may be used. Additional details regarding these features are described above in connection with the fourth example described in connection with reference number 605 of FIG. 6.

As indicated above, FIGS. 7A-7C are provided as examples. Other examples may differ from what is described with regard to FIGS. 7A-7C.

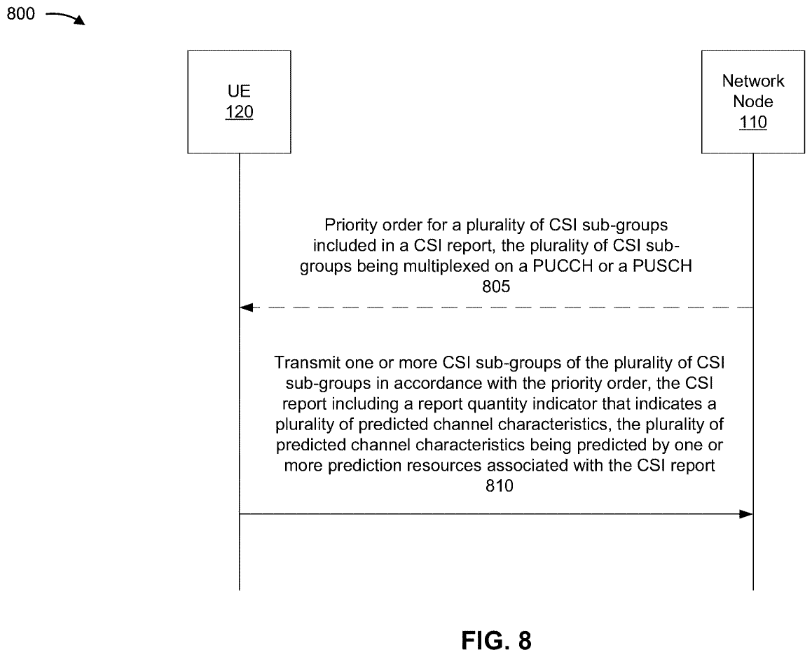

FIG. 8 is a diagram illustrating an example 800 of priority rules for intra-CSI reporting, in accordance with the present disclosure.

As shown by reference number 805, the UE 120 may obtain a priority order for transmitting a plurality of CSI sub-groups via a CSI report. The priority order for transmitting the plurality of CSI sub-groups via the CSI report may include one or more priority orders for transmitting different part-2 CSI payload sub-groups that are multiplexed on a PUCCH or a PUSCH. The UE 120 may obtain the priority order in accordance with configuration information stored at the UE 120. Additionally, or alternatively, the UE 120 may receive an indication of the priority order from the network node 110. A report quantity indicator (reportQuantity) of the CSI report may include one or more predicted channel characteristics associated with one or more prediction resources, where the one or more prediction resources are associated with (e.g., linked to) the CSI report. In some aspects, the priority order may be used to determine whether the UE 120 is to include one or more of the CSI sub-groups in the CSI report, for example, in accordance with PUCCH or PUSCH payload information. In some aspects, the prediction resources associated with (e.g., linked with) the CSI report may be based at least in part on SSBs, CSI-RSs, or virtual resources that are not actually transmitted by the network node 110 and/or which are not intended to be measured by the UE 120. In some aspects, the predicted channel characteristics may include at least one of an L1-RSRP, L1-SINR, top-K resources associated with the L1-RSRP, or top-K resources associated with the L1-SINR, among other examples.

The predicted channel characteristics associated with the prediction resources may be identified based at least in part on measurement resources (such as SSBs, CSI-RSs, or DMRSs) that are associated with the CSI report. For SD beam prediction, the predicted channel characteristics may be associated with a same TD occasion that is used by the UE to perform measurements associated with the measurement resources, where the prediction resources and measurement resources include (fully or partially) non-overlapping transmission spatial filters. For TD beam prediction, the predicted channel characteristics may be associated with a TD occasion that is later than the TD occasion that is used by the UE to perform measurements associated with the measurement resources, or that is later than a TD occasion that is used by the UE for transmitting the CSI report to the network node. For FD beam prediction, the prediction resources and measurement resources may be associated with different frequency spectrums (e.g., different frequency ranges, frequency bands, or component carriers, among other examples).

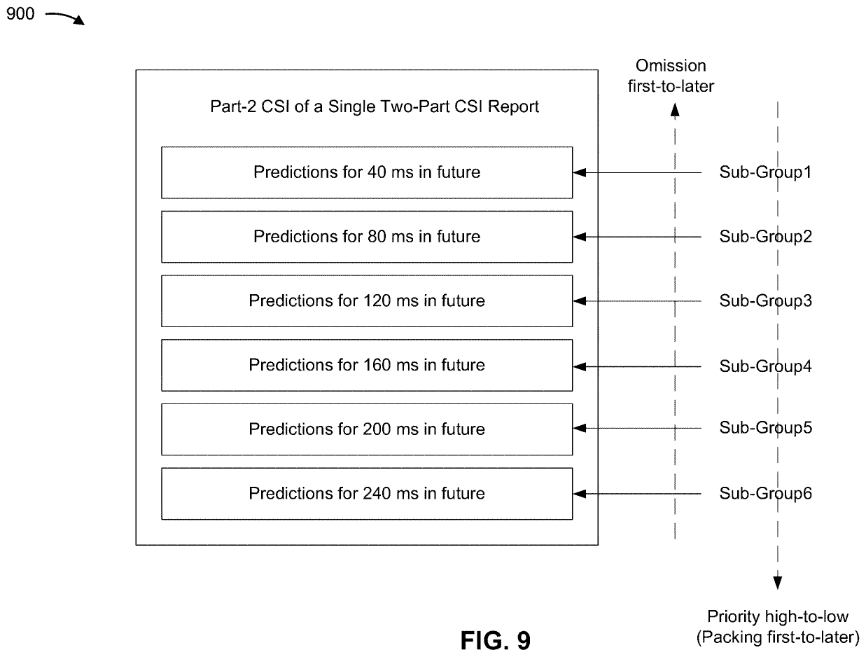

In some aspects, the UE 120 may obtain or identify a part-2 CSI omission order for TD beam prediction scenarios. The Part-2 CSI may include multiple sub-groups of predicted channel characteristics, where the different sub-groups are associated with different future TD occasions. The CSI sub-groups may be priority ordered in ascending order in accordance with the following: the future TD occasion and the TD occasion where the CSI report is transmitted; and the future TD occasion and the last TD occasion where the UE measures the measurement resources associated with the CSI report. In some aspects, packing of the CSI report may be in accordance with the same priority order (or a different priority order). If CSI omission is needed, the omission may be carried out in accordance with the priority orders of the CSI sub-groups. For example, the sub-groups including low priority orders are omitted first, while sub-groups including higher priority orders are omitted later. Additional details regarding these features are described in connection with FIG. 9.

As shown by reference number 810, the UE 120 may selectively transmit one or more CSI sub-groups of the plurality of CSI sub-groups in accordance with the priority order. For example, the UE 120 may transmit, and the network node 110 may receive, a CSI report that includes one or more CSI sub-groups of the plurality of sub-groups in accordance with the priority order. In one example, the UE 120 may transmit a first CSI sub-group and may drop (e.g., refrain from transmitting) a second CSI sub-group in accordance with the first CSI sub-group having a higher priority than the second CSI sub-group. In another example, the UE 120 may transmit a first CSI sub-group prior to transmitting a second CSI sub-group in accordance with the first CSI sub-group having a higher priority than the second CSI sub-group.

As indicated above, FIG. 8 is provided as an example. Other examples may differ from what is described with regard to FIG. 8.

FIG. 9 is a diagram illustrating an example 900 of CSI report priorities for intra-CSI, in accordance with the present disclosure. A part-2 CSI of a single two-part CSI report may include six CSI sub-groups. Sub-group1 is associated with predictions for 40 milliseconds (ms) in the future, sub-group2 is associated with predictions for 80 ms in the future, sub-group 3 is associated with predictions for 120 ms in the future, sub-group4 is associated with predictions for 160 ms in the future, sub-group5 is associated with predictions for 200 ms in the future, and sub-group6 is associated with predictions for 240 ms in the future. The CSI sub-groups may be packed in ascending order. For example, the CSI sub-groups may be packed in the following order: sub-group1, sub-group2, sub-group3, sub-group4, sub-group5, and sub-group6. The CSI sub-groups may be omitted in descending order. For example, the CSI sub-groups may be omitted in the following order: sub-group6, sub-group5, sub-group4, sub-group3, sub-group2, and sub-group1. Additional details regarding these features are described in connection with FIG. 8.

As indicated above, FIG. 9 is provided as an example. Other examples may differ from what is described with regard to FIG. 9.

FIG. 10 is a diagram illustrating an example process 1000 performed, for example, by a UE, in accordance with the present disclosure. Example process 1000 is an example where the UE (e.g., UE 120) performs operations associated with channel state information reporting.

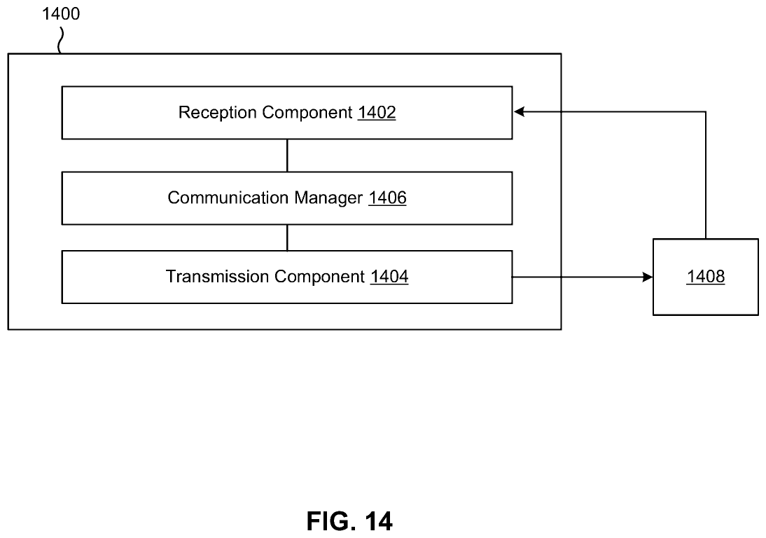

As shown in FIG. 10, in some aspects, process 1000 may include identifying a priority order for transmitting a CSI report (block 1010). For example, the UE (e.g., using communication manager 1406, depicted in FIG. 14) may identify a priority order for transmitting a CSI report, as described above.

As further shown in FIG. 10, in some aspects, process 1000 may include selectively transmitting the CSI report in accordance with the priority order, the CSI report including a report quantity indicator that indicates one or more predicted channel characteristics, the one or more predicted channel characteristics being predicted by one or more prediction resources associated with the CSI report (block 1020). For example, the UE (e.g., using transmission component 1404 and/or communication manager 1406, depicted in FIG. 14) may selectively transmit the CSI report in accordance with the priority order, the CSI report including a report quantity indicator that indicates one or more predicted channel characteristics, the one or more predicted channel characteristics being predicted by one or more prediction resources associated with the CSI report, as described above.

Process 1000 may include additional aspects, such as any single aspect or any combination of aspects described below and/or in connection with one or more other processes described elsewhere herein.

In a first aspect, selectively transmitting the CSI report in accordance with the priority order comprises transmitting a first CSI report having a higher priority in the priority order prior to transmitting a second CSI report having a lower priority in the priority order, or transmitting the first CSI report having the higher priority in the priority order and refraining from transmitting the second CSI report having the lower priority in the priority order.

In a second aspect, alone or in combination with the first aspect, process 1000 includes determining to transmit the CSI report at a feedback occasion or to refrain from transmitting the CSI report at the feedback occasion in accordance with the priority order, wherein the one or more prediction resources are based at least in part on a synchronization signal block, a CSI reference signal, or a virtual resource, and wherein the one or more predicted channel characteristics are based at least in part on a Layer 1(L1) RSRP, an L1 SINR, a top quantity of resources associated with the L1 RSRP, or a top quantity of resources associated with the L1 SINR.

In a third aspect, alone or in combination with one or more of the first and second aspects, process 1000 includes identifying the one or more predicted channel characteristics based at least in part on one or more measurement resources used for performing measurements associated with the CSI report, wherein the one or more measurement resources include at least one of a synchronization signal block, a CSI reference signal, or a demodulation reference signal.

In a fourth aspect, alone or in combination with one or more of the first through third aspects, the one or more predicted channel characteristics are predicted during a same time domain occasion used for performing measurements associated with the one or more measurement resources, wherein the one or more prediction resources and the one or more measurement resources include non-overlapping transmission spatial filters.

In a fifth aspect, alone or in combination with one or more of the first through fourth aspects, the one or more predicted channel characteristics are predicted during a time domain occasion that is later than a time domain occasion used for performing measurements associated with the one or more measurement resources or that is later than a time domain occasion used for transmitting the CSI report.

In a sixth aspect, alone or in combination with one or more of the first through fifth aspects, the one or more prediction resources are associated with a frequency spectrum that is different than a frequency spectrum associated with the one or more measurement resources.

In a seventh aspect, alone or in combination with one or more of the first through sixth aspects, the CSI report is a first CSI report and the report quantity indicator is a first report quantity indicator, wherein identifying the priority order for the CSI report comprises identifying a first priority order for the first CSI report that is a same priority order as a second priority order for a second CSI report based at least in part on the second CSI report having a second report quantity indicator that indicates a measured L1 RSRP or L1 SINR, wherein the first report quantity indicator that indicates the one or more predicted channel characteristics indicates at least one of a predicted L1RSRP, a predicted L1 SINR, or a predicted top quantity of resources.

In an eighth aspect, alone or in combination with one or more of the first through seventh aspects, the CSI report is a first CSI report that includes a time domain beam prediction report associated with a single serving cell and the report quantity indicator is a first report quantity indicator, wherein identifying the priority order for the CSI report comprises identifying a first priority order for the first CSI report that is lower than a second priority order for a second CSI report and is higher than a third priority order for a third CSI report that does not include a measured or predicted L1RSRP or L1 SINR, wherein identifying that the first priority order for the first CSI report is lower than the second priority order for the second CSI report comprises identifying that the first priority order for the first CSI report is lower than the second priority order for the second CSI report based at least in part on the second CSI report including an L1 RSRP or L1 SINR or based at least in part on the second CSI report including a predicted L1 RSRP, a predicted L1 SINR, or a predicted top quantity of resources not associated with a future measurement occasion, and wherein the first report quantity indicator that indicates the one or more predicted channel characteristics indicates at least one of a predicted L1 RSRP, a predicted L1 SINR, or a predicted top quantity of resources.

In a ninth aspect, alone or in combination with one or more of the first through eighth aspects, process 1000 includes identifying at least one of the first priority order, the second priority order, or the third priority order based at least in part on whether the first CSI report, the second CSI report, or the third CSI report is associated with a periodic transmission, a semi-persistent transmission, an aperiodic transmission, a physical uplink shared channel transmission, or a physical uplink control channel transmission.

In a tenth aspect, alone or in combination with one or more of the first through ninth aspects, the CSI report includes a time domain beam prediction report associated with a plurality of serving cells, wherein identifying the priority order for the CSI report comprises identifying the priority order for the CSI report in accordance with an indication received from a network node, wherein the report quantity indicator that indicates the one or more predicted channel characteristics indicates at least one of a predicted L1 reference signal received power, a predicted L1 signal-to-interference-plus-noise ratio, or a predicted top quantity of resources.

In an eleventh aspect, alone or in combination with one or more of the first through tenth aspects, identifying the priority order for the CSI report further comprises identifying the priority order for the CSI report in accordance with one or more prediction resources associated with one or more serving cells of the plurality of serving cells that are different from a serving cell of the plurality of serving cells that is an active serving cell for the UE.

In a twelfth aspect, alone or in combination with one or more of the first through eleventh aspects, the CSI report includes a beam prediction report for predicting a top quantity of resources, wherein identifying the priority order for the CSI report comprises identifying the priority order for the CSI report in accordance with an indication received from a network node, wherein the report quantity indicator that indicates the one or more predicted channel characteristics indicates the top quantity of resources associated with an L1 reference signal received power or an L1 signal-to-interference-plus-noise ratio.

In a thirteenth aspect, alone or in combination with one or more of the first through twelfth aspects, the CSI report includes a frequency domain beam prediction report, wherein identifying the priority order for the CSI report comprises identifying the priority order for the CSI report in accordance with an indication received from a network node, wherein the report quantity indicator that indicates the one or more predicted channel characteristics indicates at least one of a predicted L1 reference signal received power, a predicted L1 signal-to-interference-plus-noise ratio, or a predicted top quantity of resources.

In a fourteenth aspect, alone or in combination with one or more of the first through thirteenth aspects, identifying the priority order for the CSI report further comprises identifying the priority order for the CSI report in accordance with the one or more prediction resources being associated with a frequency spectrum that is different than a frequency spectrum associated with one or more measurement resources for performing measurements associated with the CSI report.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a UE, in accordance with the present disclosure. Example process 1100 is an example where the UE (e.g., UE 120) performs operations associated with channel state information reporting.

As shown in FIG. 11, in some aspects, process 1100 may include identifying a priority order for transmitting a plurality of CSI sub-groups via a CSI report, the plurality of CSI sub-groups being multiplexed on a PUCCH or a PUSCH (block 1110). For example, the UE (e.g., using communication manager 1406, depicted in FIG. 14) may identify a priority order for transmitting a plurality of CSI sub-groups via a CSI report, the plurality of CSI sub-groups being multiplexed on a PUCCH or a PUSCH, as described above.

As further shown in FIG. 11, in some aspects, process 1100 may include selectively transmitting one or more CSI sub-groups of the plurality of CSI sub-groups in accordance with the priority order, the CSI report including a report quantity indicator that indicates a plurality of predicted channel characteristics, the plurality of predicted channel characteristics being predicted by one or more prediction resources associated with the CSI report (block 1120). For example, the UE (e.g., using transmission component 1404 and/or communication manager 1406, depicted in FIG. 14) may selectively transmit one or more CSI sub-groups of the plurality of CSI sub-groups in accordance with the priority order, the CSI report including a report quantity indicator that indicates a plurality of predicted channel characteristics, the plurality of predicted channel characteristics being predicted by one or more prediction resources associated with the CSI report, as described above.

Process 1100 may include additional aspects, such as any single aspect or any combination of aspects described below and/or in connection with one or more other processes described elsewhere herein.

In a first aspect, selectively transmitting the one or more CSI sub-groups in accordance with the priority order comprises refraining from transmitting a CSI sub-group having a lower priority order prior to refraining from transmitting another CSI sub-group having a higher priority order.

In a second aspect, alone or in combination with the first aspect, process 1100 includes determining to transmit the one or more CSI sub-groups at a feedback occasion or to refrain from transmitting the one or more CSI sub-groups at a feedback occasion in accordance with the priority order, wherein the one or more prediction resources are based at least in part on a synchronization signal block, a CSI reference signal, or a virtual resource, and wherein the plurality of predicted channel characteristics are based at least in part on an L1 RSRP, an L1 SINR, a top quantity of resources associated with the L1 RSRP, or a top quantity of resources associated with the L1 SINR.

In a third aspect, alone or in combination with one or more of the first and second aspects, process 1100 includes identifying the plurality of predicted channel characteristics based at least in part on one or more measurement resources associated with the CSI report, wherein the one or more measurement resources include at least one of a synchronization signal block, a CSI reference signal, or a demodulation reference signal.

In a fourth aspect, alone or in combination with one or more of the first through third aspects, the plurality of predicted channel characteristics are predicted during a same time domain occasion used for performing measurements associated with the one or more measurement resources, wherein the one or more prediction resources and the one or more measurement resources include non-overlapping transmission spatial filters.

In a fifth aspect, alone or in combination with one or more of the first through fourth aspects, the plurality of predicted channel characteristics are predicted during a time occasion that is later than a time occasion used for performing measurements associated with the one or more measurement resources or that is later than a time occasion used for transmitting the CSI report.

In a sixth aspect, alone or in combination with one or more of the first through fifth aspects, the one or more prediction resources are associated with a frequency spectrum that is different than a frequency spectrum associated with the one or more measurement resources.

In a seventh aspect, alone or in combination with one or more of the first through sixth aspects, the plurality of CSI sub-groups are associated with the plurality of predicted channel characteristics, and each CSI sub-group of the plurality of CSI sub-groups corresponds to a respective future time domain occasion of a plurality of future time domain occasions.

In an eighth aspect, alone or in combination with one or more of the first through seventh aspects, process 1100 includes determining a priority order for a CSI sub-group of the plurality of CSI sub-groups based at least in part on a future time domain occasion that corresponds to the CSI sub-group and a time domain occasion that corresponds to a transmission of the CSI report.

In a ninth aspect, alone or in combination with one or more of the first through eighth aspects, process 1100 includes determining a priority order for a CSI sub-group of the plurality of CSI sub-groups based at least in part on a future time domain occasion that corresponds to the CSI sub-group and a time domain occasion that corresponds to a most recent time domain occasion during which one or more measurements are performed using one or more measurement resources associated with the CSI report.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, by a network node, in accordance with the present disclosure. Example process 1200 is an example where the network node (e.g., network node 110) performs operations associated with channel state information reporting.

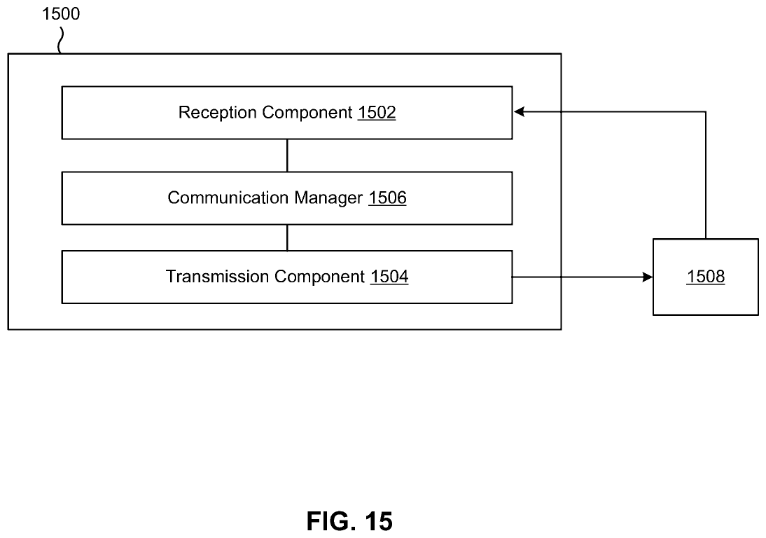

As shown in FIG. 12, in some aspects, process 1200 may include transmitting an indication of a priority order for CSI reporting (block 1210). For example, the network node (e.g., using transmission component 1504 and/or communication manager 1506, depicted in FIG. 15) may transmit an indication of a priority order for CSI reporting, as described above.

As further shown in FIG. 12, in some aspects, process 1200 may include receiving a CSI report in accordance with the priority order, the CSI report including a report quantity indicator that indicates one or more predicted channel characteristics, the one or more predicted channel characteristics being predicted by one or more prediction resources associated with the CSI report (block 1220). For example, the network node (e.g., using reception component 1502 and/or communication manager 1506, depicted in FIG. 15) may receive a CSI report in accordance with the priority order, the CSI report including a report quantity indicator that indicates one or more predicted channel characteristics, the one or more predicted channel characteristics being predicted by one or more prediction resources associated with the CSI report, as described above.

Process 1200 may include additional aspects, such as any single aspect or any combination of aspects described below and/or in connection with one or more other processes described elsewhere herein.

In a first aspect, the one or more prediction resources are associated with a synchronization signal block, a CSI reference signal, or a virtual resource, and the one or more predicted channel characteristics are based at least in part on an L1 RSRP, an L1 SINR, a top quantity of resources associated with the L1 RSRP, or a top quantity of resources associated with the L1 SINR.

In a second aspect, alone or in combination with the first aspect, the one or more predicted channel characteristics are associated with one or more measurement resources associated with the CSI report, wherein the one or more measurement resources include at least one of a synchronization signal block, a CSI reference signal, or a demodulation reference signal.

In a third aspect, alone or in combination with one or more of the first and second aspects, the one or more predicted channel characteristics are associated with a same time domain occasion used for measurements associated with the one or more measurement resources, wherein the one or more prediction resources and the one or more measurement resources include non-overlapping transmission spatial filters.

In a fourth aspect, alone or in combination with one or more of the first through third aspects, the one or more predicted channel characteristics are associated with a time occasion that is later than a time occasion used for measurements associated with the one or more measurement resources or that is later than a time occasion used for receiving the CSI report.

In a fifth aspect, alone or in combination with one or more of the first through fourth aspects, the one or more prediction resources are associated with a frequency spectrum that is different than a frequency spectrum associated with the one or more measurement resources.

In a sixth aspect, alone or in combination with one or more of the first through fifth aspects, the CSI report is a first CSI report and the report quantity indicator is a first report quantity indicator, wherein a first priority order for the first CSI report is a same priority order as a second priority order for a second CSI report based at least in part on the second CSI report having a second report quantity indicator that indicates a measured L1 RSRP or L1 SINR, wherein the first report quantity indicator that indicates the one or more predicted channel characteristics indicates at least one of a predicted L1 RSRP, a predicted L1 SINR, or a predicted top quantity of resources.

In a seventh aspect, alone or in combination with one or more of the first through sixth aspects, the CSI report is a first CSI report that includes a time domain beam prediction report associated with a single serving cell and the report quantity indicator is a first report quantity indicator, wherein a first priority order for the first CSI report is lower than a second priority order for a second CSI report based at least in part on the second CSI report including an L1 RSRP or L1 SINR or based at least in part on the second CSI report including a predicted L1 RSRP, L1 SINR, or top quantity of resources not associated with a future measurement occasion, and that is higher than a third priority order for a third CSI report that does not include a measured or predicted L1 RSRP or L1 SINR, wherein the first report quantity indicator that indicates the one or more predicted channel characteristics indicates at least one of a predicted L1 RSRP, a predicted L1 SINR, or a predicted top quantity of resources.

In an eighth aspect, alone or in combination with one or more of the first through seventh aspects, process 1200 includes transmitting information associated with determining the priority order for the CSI report, wherein the CSI report includes a time domain beam prediction report associated with a plurality of serving cells, and wherein the report quantity indicator that indicates the one or more predicted channel characteristics indicates at least one of a predicted L1 reference signal received power, a predicted L1 SINR, or a predicted top quantity of resources.

In a ninth aspect, alone or in combination with one or more of the first through eighth aspects, the priority order for the CSI report is based at least in part on one or more prediction resources associated with one or more serving cells of the plurality of serving cells that are different from a serving cell of the plurality of serving cells that is an active serving cell for a UE transmitting the CSI report.

In a tenth aspect, alone or in combination with one or more of the first through ninth aspects, process 1200 includes transmitting information associated with determining the priority order for the CSI report, wherein the CSI report includes a beam prediction report for predicting a top quantity of resources, and wherein the report quantity indicator that indicates the one or more predicted channel characteristics indicates the top quantity of resources associated with an L1 reference signal received power or an L1 signal-to-interference-plus-noise ratio.

In an eleventh aspect, alone or in combination with one or more of the first through tenth aspects, process 1200 includes transmitting information associated with determining the priority order for the CSI report, wherein the CSI report includes a frequency domain beam prediction report, and wherein the report quantity indicator that indicates the one or more predicted channel characteristics indicates at least one of a predicted L1 reference signal received power, a predicted L1 SINR, or a predicted top quantity of resources.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram illustrating an example process 1300 performed, for example, by a network node, in accordance with the present disclosure. Example process 1300 is an example where the network node (e.g., network node 110) performs operations associated with channel state information reporting.

As shown in FIG. 13, in some aspects, process 1300 may include transmitting a priority order for a plurality of CSI sub-groups included in a CSI report, the plurality of CSI sub-groups being multiplexed on a PUCCH or a PUSCH (block 1310). For example, the network node (e.g., using transmission component 1504 and/or communication manager 1506, depicted in FIG. 15) may transmit a priority order for a plurality of CSI sub-groups included in a CSI report, the plurality of CSI sub-groups being multiplexed on a PUCCH or a PUSCH, as described above.

As further shown in FIG. 13, in some aspects, process 1300 may include receiving one or more CSI sub-groups of the plurality of CSI sub-groups in accordance with the priority order, the CSI report including a report quantity indicator that indicates a plurality of predicted channel characteristics, the plurality of predicted channel characteristics being predicted by one or more prediction resources associated with the CSI report (block 1320). For example, the network node (e.g., using reception component 1502 and/or communication manager 1506, depicted in FIG. 15) may receive one or more CSI sub-groups of the plurality of CSI sub-groups in accordance with the priority order, the CSI report including a report quantity indicator that indicates a plurality of predicted channel characteristics, the plurality of predicted channel characteristics being predicted by one or more prediction resources associated with the CSI report, as described above.

Process 1300 may include additional aspects, such as any single aspect or any combination of aspects described below and/or in connection with one or more other processes described elsewhere herein.

In a first aspect, the one or more prediction resources are based at least in part on a synchronization signal block, a CSI reference signal, or a virtual resource, and the plurality of predicted channel characteristics are based at least in part on an L1 RSRP, an L1 SINR, a top quantity of resources associated with the L1 RSRP, or a top quantity of resources associated with the L1 SINR.

In a second aspect, alone or in combination with the first aspect, the plurality of predicted channel characteristics are based at least in part on one or more measurement resources associated with the CSI report, and the one or more measurement resources include at least one of a synchronization signal block, a CSI reference signal, or a demodulation reference signal.

In a third aspect, alone or in combination with one or more of the first and second aspects, the plurality of predicted channel characteristics are predicted during a same time domain occasion used for measurements associated with the one or more measurement resources, wherein the one or more prediction resources and the one or more measurement resources include non-overlapping transmission spatial filters.

In a fourth aspect, alone or in combination with one or more of the first through third aspects, the plurality of predicted channel characteristics are predicted during a time occasion that is later than a time occasion for measurements associated with the one or more measurement resources or that is later than a time occasion used for transmitting the CSI report.

In a fifth aspect, alone or in combination with one or more of the first through fourth aspects, the one or more prediction resources are associated with a frequency spectrum that is different than a frequency spectrum associated with the one or more measurement resources.

In a sixth aspect, alone or in combination with one or more of the first through fifth aspects, the plurality of CSI sub-groups are associated with the plurality of predicted channel characteristics, and each CSI sub-group of the plurality of CSI sub-groups corresponds to a respective future time domain occasion of a plurality of future time domain occasions.

In a seventh aspect, alone or in combination with one or more of the first through sixth aspects, a priority order for a CSI sub-group of the plurality of CSI sub-groups is determined based at least in part on a future time domain occasion that corresponds to the CSI sub-group and a time domain occasion that corresponds to a transmission of the CSI report.

In an eighth aspect, alone or in combination with one or more of the first through seventh aspects, a priority order for a CSI sub-group of the plurality of CSI sub-groups is determined based at least in part on a future time domain occasion that corresponds to the CSI sub-group and a time domain occasion that corresponds to a most recent time domain occasion during which one or more measurements are performed using one or more measurement resources associated with the CSI report.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram of an example apparatus 1400 for wireless communication, in accordance with the present disclosure. The apparatus 1400 may be a UE, or a UE may include the apparatus 1400. In some aspects, the apparatus 1400 includes a reception component 1402, a transmission component 1404, and/or a communication manager 1406, which may be in communication with one another (for example, via one or more buses and/or one or more other components). In some aspects, the communication manager 1406 is the communication manager 140 described in connection with FIG. 1. As shown, the apparatus 1400 may communicate with another apparatus 1408, such as a UE or a network node (such as a CU, a DU, an RU, or a base station), using the reception component 1402 and the transmission component 1404.

In some aspects, the apparatus 1400 may be configured to perform one or more operations described herein in connection with FIGS. 6-9. Additionally, or alternatively, the apparatus 1400 may be configured to perform one or more processes described herein, such as process 1000 of FIG. 10, process 1100 of FIG. 11, or a combination thereof. In some aspects, the apparatus 1400 and/or one or more components shown in FIG. 14 may include one or more components of the UE described in connection with FIG. 2. Additionally, or alternatively, one or more components shown in FIG. 14 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1402 may receive communications, such as reference signals, control information, data communications, or a combination thereof, from the apparatus 1408. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1400. In some aspects, the reception component 1402 may include one or more antennas, a modem, a demodulator, a MIMO detector, a receive processor, a controller/processor, a memory, or a combination thereof, of the UE described in connection with FIG. 2.

The transmission component 1404 may transmit communications, such as reference signals, control information, data communications, or a combination thereof, to the apparatus 1408. In some aspects, one or more other components of the apparatus 1400 may generate communications and may provide the generated communications to the transmission component 1404 for transmission to the apparatus 1408. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1408. In some aspects, the transmission component 1404 may include one or more antennas, a modem, a modulator, a transmit MIMO processor, a transmit processor, a controller/processor, a memory, or a combination thereof, of the UE described in connection with FIG. 2. In some aspects, the transmission component 1404 may be co-located with the reception component 1402 in a transceiver.

The communication manager 1406 may support operations of the reception component 1402 and/or the transmission component 1404. For example, the communication manager 1406 may receive information associated with configuring reception of communications by the reception component 1402 and/or transmission of communications by the transmission component 1404. Additionally, or alternatively, the communication manager 1406 may generate and/or provide control information to the reception component 1402 and/or the transmission component 1404 to control reception and/or transmission of communications.

The communication manager 1406 may identify a priority order for transmitting a CSI report. The transmission component 1404 may selectively transmit the CSI report in accordance with the priority order, the CSI report including a report quantity indicator that indicates one or more predicted channel characteristics, the one or more predicted channel characteristics being predicted by one or more prediction resources associated with the CSI report.

The communication manager 1406 may determine to transmit the CSI report at a feedback occasion or to refrain from transmitting the CSI report at the feedback occasion in accordance with the priority order, wherein the one or more prediction resources are based at least in part on a synchronization signal block, a CSI reference signal, or a virtual resource, and wherein the one or more predicted channel characteristics are based at least in part on a Layer 1 (L1) RSRP, an L1 SINR, a top quantity of resources associated with the L1 RSRP, or a top quantity of resources associated with the L1 SINR. The communication manager 1406 may identify the one or more predicted channel characteristics based at least in part on one or more measurement resources used for performing measurements associated with the CSI report, wherein the one or more measurement resources include at least one of a synchronization signal block, a CSI reference signal, or a demodulation reference signal. The communication manager 1406 may identify at least one of the first priority order, the second priority order, or the third priority order based at least in part on whether the first CSI report, the second CSI report, or the third CSI report is associated with a periodic transmission, a semi-persistent transmission, an aperiodic transmission, a physical uplink shared channel transmission, or a physical uplink control channel transmission.

The communication manager 1406 may identify a priority order for transmitting a plurality of CSI sub-groups via a CSI report, the plurality of CSI sub-groups being multiplexed on a PUCCH or a PUSCH. The transmission component 1404 may selectively transmit one or more CSI sub-groups of the plurality of CSI sub-groups in accordance with the priority order, the CSI report including a report quantity indicator that indicates a plurality of predicted channel characteristics, the plurality of predicted channel characteristics being predicted by one or more prediction resources associated with the CSI report.

The communication manager 1406 may determine to transmit the one or more CSI sub-groups at a feedback occasion or to refrain from transmitting the one or more CSI sub-groups at a feedback occasion in accordance with the priority order, wherein the one or more prediction resources are based at least in part on a synchronization signal block, a CSI reference signal, or a virtual resource, and wherein the plurality of predicted channel characteristics are based at least in part on an L1 RSRP, an L1 SINR, a top quantity of resources associated with the L1 RSRP, or a top quantity of resources associated with the L1 SINR. The communication manager 1406 may identify the plurality of predicted channel characteristics based at least in part on one or more measurement resources associated with the CSI report, wherein the one or more measurement resources include at least one of a synchronization signal block, a CSI reference signal, or a demodulation reference signal. The communication manager 1406 may determine a priority order for a CSI sub-group of the plurality of CSI sub-groups based at least in part on a future time domain occasion that corresponds to the CSI sub-group and a time domain occasion that corresponds to a transmission of the CSI report. The communication manager 1406 may determine a priority order for a CSI sub-group of the plurality of CSI sub-groups based at least in part on a future time domain occasion that corresponds to the CSI sub-group and a time domain occasion that corresponds to a most recent time domain occasion during which one or more measurements are performed using one or more measurement resources associated with the CSI report.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

FIG. 15 is a diagram of an example apparatus 1500 for wireless communication, in accordance with the present disclosure. The apparatus 1500 may be a network node, or a network node may include the apparatus 1500. In some aspects, the apparatus 1500 includes a reception component 1502, a transmission component 1504, and/or a communication manager 1506, which may be in communication with one another (for example, via one or more buses and/or one or more other components). In some aspects, the communication manager 1506 is the communication manager 150 described in connection with FIG. 1. As shown, the apparatus 1500 may communicate with another apparatus 1508, such as a UE or a network node (such as a CU, a DU, an RU, or a base station), using the reception component 1502 and the transmission component 1504.

In some aspects, the apparatus 1500 may be configured to perform one or more operations described herein in connection with FIGS. 6-9. Additionally, or alternatively, the apparatus 1500 may be configured to perform one or more processes described herein, such as process 1200 of FIG. 12, process 1300 of FIG. 13, or a combination thereof. In some aspects, the apparatus 1500 and/or one or more components shown in FIG. 15 may include one or more components of the network node described in connection with FIG. 2. Additionally, or alternatively, one or more components shown in FIG. 15 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1502 may receive communications, such as reference signals, control information, data communications, or a combination thereof, from the apparatus 1508. The reception component 1502 may provide received communications to one or more other components of the apparatus 1500. In some aspects, the reception component 1502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1500. In some aspects, the reception component 1502 may include one or more antennas, a modem, a demodulator, a MIMO detector, a receive processor, a controller/processor, a memory, or a combination thereof, of the network node described in connection with FIG. 2. In some aspects, the reception component 1502 and/or the transmission component 1504 may include or may be included in a network interface. The network interface may be configured to obtain and/or output signals for the apparatus 1500 via one or more communications links, such as a backhaul link, a midhaul link, and/or a fronthaul link.

The transmission component 1504 may transmit communications, such as reference signals, control information, data communications, or a combination thereof, to the apparatus 1508. In some aspects, one or more other components of the apparatus 1500 may generate communications and may provide the generated communications to the transmission component 1504 for transmission to the apparatus 1508. In some aspects, the transmission component 1504 may perform signal processing on the generated communications (such as filtering, amplification, modulation, digital-to-analog conversion, multiplexing, interleaving, mapping, or encoding, among other examples), and may transmit the processed signals to the apparatus 1508. In some aspects, the transmission component 1504 may include one or more antennas, a modem, a modulator, a transmit MIMO processor, a transmit processor, a controller/processor, a memory, or a combination thereof, of the network node described in connection with FIG. 2. In some aspects, the transmission component 1504 may be co-located with the reception component 1502 in a transceiver.

The communication manager 1506 may support operations of the reception component 1502 and/or the transmission component 1504. For example, the communication manager 1506 may receive information associated with configuring reception of communications by the reception component 1502 and/or transmission of communications by the transmission component 1504. Additionally, or alternatively, the communication manager 1506 may generate and/or provide control information to the reception component 1502 and/or the transmission component 1504 to control reception and/or transmission of communications.

The transmission component 1504 may transmit an indication of a priority order for CSI reporting. The reception component 1502 may receive a CSI report in accordance with the priority order, the CSI report including a report quantity indicator that indicates one or more predicted channel characteristics, the one or more predicted channel characteristics being predicted by one or more prediction resources associated with the CSI report.

The transmission component 1504 may transmit information associated with determining the priority order for the CSI report, wherein the CSI report includes a time domain beam prediction report associated with a plurality of serving cells, and wherein the report quantity indicator that indicates the one or more predicted channel characteristics indicates at least one of a predicted L1 reference signal received power, a predicted L1 SINR, or a predicted top quantity of resources.

The transmission component 1504 may transmit information associated with determining the priority order for the CSI report, wherein the CSI report includes a beam prediction report for predicting a top quantity of resources, and wherein the report quantity indicator that indicates the one or more predicted channel characteristics indicates the top quantity of resources associated with an L1 reference signal received power or an L1 signal-to-interference-plus-noise ratio.

The transmission component 1504 may transmit information associated with determining the priority order for the CSI report, wherein the CSI report includes a frequency domain beam prediction report, and wherein the report quantity indicator that indicates the one or more predicted channel characteristics indicates at least one of a predicted L1 reference signal received power, a predicted L1 SINR, or a predicted top quantity of resources.

The transmission component 1504 may transmit a priority order for a plurality of CSI sub-groups included in a CSI report, the plurality of CSI sub-groups being multiplexed on a PUCCH or a PUSCH. The reception component 1502 may receive one or more CSI sub-groups of the plurality of CSI sub-groups in accordance with the priority order, the CSI report including a report quantity indicator that indicates a plurality of predicted channel characteristics, the plurality of predicted channel characteristics being predicted by one or more prediction resources associated with the CSI report.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

The following provides an overview of some Aspects of the present disclosure:

Aspect 1: A method of wireless communication performed by a user equipment (UE), comprising: identifying a priority order for transmitting a channel state information (CSI) report; and selectively transmitting the CSI report in accordance with the priority order, the CSI report including a report quantity indicator that indicates one or more predicted channel characteristics, the one or more predicted channel characteristics being predicted by one or more prediction resources associated with the CSI report.

Aspect 2: The method of Aspect 1, wherein selectively transmitting the CSI report in accordance with the priority order comprises transmitting a first CSI report having a higher priority in the priority order prior to transmitting a second CSI report having a lower priority in the priority order, or transmitting the first CSI report having the higher priority in the priority order and refraining from transmitting the second CSI report having the lower priority in the priority order.

Aspect 3: The method of any of Aspects 1-2, further comprising determining to transmit the CSI report at a feedback occasion or to refrain from transmitting the CSI report at the feedback occasion in accordance with the priority order, wherein the one or more prediction resources are based at least in part on a synchronization signal block, a CSI reference signal, or a virtual resource, and wherein the one or more predicted channel characteristics are based at least in part on a Layer 1 (L1) reference signal received power (RSRP), an L1 signal-to-interference-plus-noise ratio (SINR), a top quantity of resources associated with the L1 RSRP, or a top quantity of resources associated with the L1 SINR.

Aspect 4: The method of any of Aspects 1-3, further comprising identifying the one or more predicted channel characteristics based at least in part on one or more measurement resources used for performing measurements associated with the CSI report, wherein the one or more measurement resources include at least one of a synchronization signal block, a CSI reference signal, or a demodulation reference signal.

Aspect 5: The method of Aspect 4, wherein the one or more predicted channel characteristics are predicted during a same time domain occasion used for performing measurements associated with the one or more measurement resources, wherein the one or more prediction resources and the one or more measurement resources include non-overlapping transmission spatial filters.

Aspect 6: The method of Aspect 4, wherein the one or more predicted channel characteristics are predicted during a time domain occasion that is later than a time domain occasion used for performing measurements associated with the one or more measurement resources or that is later than a time domain occasion used for transmitting the CSI report.

Aspect 7: The method of Aspect 4, wherein the one or more prediction resources are associated with a frequency spectrum that is different than a frequency spectrum associated with the one or more measurement resources.

Aspect 8: The method of any of Aspects 1-7, wherein the CSI report is a first CSI report and the report quantity indicator is a first report quantity indicator, wherein identifying the priority order for the CSI report comprises identifying a first priority order for the first CSI report that is a same priority order as a second priority order for a second CSI report based at least in part on the second CSI report having a second report quantity indicator that indicates a measured L1 reference signal received power (RSRP) or L1 signal-to-interference-plus-noise ratio (SINR), wherein the first report quantity indicator that indicates the one or more predicted channel characteristics indicates at least one of a predicted L1 RSRP, a predicted L1 SINR, or a predicted top quantity of resources.

Aspect 9: The method of any of Aspects 1-8, wherein the CSI report is a first CSI report that includes a time domain beam prediction report associated with a single serving cell and the report quantity indicator is a first report quantity indicator, wherein identifying the priority order for the CSI report comprises identifying a first priority order for the first CSI report that is lower than a second priority order for a second CSI report and is higher than a third priority order for a third CSI report that does not include a measured or predicted L1 RSRP or L1 SINR, wherein identifying that the first priority order for the first CSI report is lower than the second priority order for the second CSI report comprises identifying that the first priority order for the first CSI report is lower than the second priority order for the second CSI report based at least in part on the second CSI report including an L1 reference signal received power (RSRP) or L1 signal-to-interference-plus-noise ratio (SINR) or based at least in part on the second CSI report including a predicted L1 RSRP, a predicted L1 SINR, or a predicted top quantity of resources not associated with a future measurement occasion, and wherein the first report quantity indicator that indicates the one or more predicted channel characteristics indicates at least one of a predicted L1 RSRP, a predicted L1 SINR, or a predicted top quantity of resources.

Aspect 10: The method of Aspect 9, further comprising identifying at least one of the first priority order, the second priority order, or the third priority order based at least in part on whether the first CSI report, the second CSI report, or the third CSI report is associated with a periodic transmission, a semi-persistent transmission, an aperiodic transmission, a physical uplink shared channel transmission, or a physical uplink control channel transmission.

Aspect 11: The method of any of Aspects 1-10, wherein the CSI report includes a time domain beam prediction report associated with a plurality of serving cells, wherein identifying the priority order for the CSI report comprises identifying the priority order for the CSI report in accordance with an indication received from a network node, wherein the report quantity indicator that indicates the one or more predicted channel characteristics indicates at least one of a predicted L1 reference signal received power, a predicted L1 signal-to-interference-plus-noise ratio, or a predicted top quantity of resources.

Aspect 12: The method of Aspect 11, wherein identifying the priority order for the CSI report further comprises identifying the priority order for the CSI report in accordance with one or more prediction resources associated with one or more serving cells of the plurality of serving cells that are different from a serving cell of the plurality of serving cells that is an active serving cell for the UE.

Aspect 13: The method of any of Aspects 1-12, wherein the CSI report includes a beam prediction report for predicting a top quantity of resources, wherein identifying the priority order for the CSI report comprises identifying the priority order for the CSI report in accordance with an indication received from a network node, wherein the report quantity indicator that indicates the one or more predicted channel characteristics indicates the top quantity of resources associated with an L1 reference signal received power or an L1 signal-to-interference-plus-noise ratio.

Aspect 14: The method of any of Aspects 1-13, wherein the CSI report includes a frequency domain beam prediction report, wherein identifying the priority order for the CSI report comprises identifying the priority order for the CSI report in accordance with an indication received from a network node, wherein the report quantity indicator that indicates the one or more predicted channel characteristics indicates at least one of a predicted L1 reference signal received power, a predicted L1 signal-to-interference-plus-noise ratio, or a predicted top quantity of resources.

Aspect 15: The method of Aspect 14, wherein identifying the priority order for the CSI report further comprises identifying the priority order for the CSI report in accordance with the one or more prediction resources being associated with a frequency spectrum that is different than a frequency spectrum associated with one or more measurement resources for performing measurements associated with the CSI report.

Aspect 16: A method of wireless communication performed by a user equipment (UE), comprising: identifying a priority order for transmitting a plurality of channel state information (CSI) sub-groups via a CSI report, the plurality of CSI sub-groups being multiplexed on a physical uplink control channel (PUCCH) or a physical uplink shared channel (PUSCH); and selectively transmitting one or more CSI sub-groups of the plurality of CSI sub-groups in accordance with the priority order, the CSI report including a report quantity indicator that indicates a plurality of predicted channel characteristics, the plurality of predicted channel characteristics being predicted by one or more prediction resources associated with the CSI report.

Aspect 17: The method of Aspect 16, wherein selectively transmitting the one or more CSI sub-groups in accordance with the priority order comprises refraining from transmitting a CSI sub-group having a lower priority order prior to refraining from transmitting another CSI sub-group having a higher priority order.

Aspect 18: The method of any of Aspects 16-17, further comprising determining to transmit the one or more CSI sub-groups at a feedback occasion or to refrain from transmitting the one or more CSI sub-groups at a feedback occasion in accordance with the priority order, wherein the one or more prediction resources are based at least in part on a synchronization signal block, a CSI reference signal, or a virtual resource, and wherein the plurality of predicted channel characteristics are based at least in part on a Layer 1 (L1) reference signal received power (RSRP), an L1 signal-to-interference-plus-noise ratio (SINR), a top quantity of resources associated with the L1 RSRP, or a top quantity of resources associated with the L1 SINR.

Aspect 19: The method of any of Aspects 16-18, further comprising identifying the plurality of predicted channel characteristics based at least in part on one or more measurement resources associated with the CSI report, wherein the one or more measurement resources include at least one of a synchronization signal block, a CSI reference signal, or a demodulation reference signal.

Aspect 20: The method of Aspect 19, wherein the plurality of predicted channel characteristics are predicted during a same time domain occasion used for performing measurements associated with the one or more measurement resources, wherein the one or more prediction resources and the one or more measurement resources include non-overlapping transmission spatial filters.

Aspect 21: The method of Aspect 19, wherein the plurality of predicted channel characteristics are predicted during a time occasion that is later than a time occasion used for performing measurements associated with the one or more measurement resources or that is later than a time occasion used for transmitting the CSI report.

Aspect 22: The method of Aspect 19, wherein the one or more prediction resources are associated with a frequency spectrum that is different than a frequency spectrum associated with the one or more measurement resources.

Aspect 23: The method of any of Aspects 16-22, wherein the plurality of CSI sub-groups are associated with the plurality of predicted channel characteristics, and wherein each CSI sub-group of the plurality of CSI sub-groups corresponds to a respective future time domain occasion of a plurality of future time domain occasions.

Aspect 24: The method of Aspect 23, further comprising determining a priority order for a CSI sub-group of the plurality of CSI sub-groups based at least in part on a future time domain occasion that corresponds to the CSI sub-group and a time domain occasion that corresponds to a transmission of the CSI report.

Aspect 25: The method of Aspect 23, further comprising determining a priority order for a CSI sub-group of the plurality of CSI sub-groups based at least in part on a future time domain occasion that corresponds to the CSI sub-group and a time domain occasion that corresponds to a most recent time domain occasion during which one or more measurements are performed using one or more measurement resources associated with the CSI report.

Aspect 26: A method of wireless communication performed by a network node, comprising: transmitting an indication of a priority order for channel state information (CSI) reporting; and receiving a CSI report in accordance with the priority order, the CSI report including a report quantity indicator that indicates one or more predicted channel characteristics, the one or more predicted channel characteristics being predicted by one or more prediction resources associated with the CSI report.

Aspect 27: The method of Aspect 26, wherein the one or more prediction resources are associated with a synchronization signal block, a CSI reference signal, or a virtual resource, and wherein the one or more predicted channel characteristics are based at least in part on a Layer 1 (L1) reference signal received power (RSRP), an L1 signal-to-interference-plus-noise ratio (SINR), a top quantity of resources associated with the L1 RSRP, or a top quantity of resources associated with the L1 SINR.

Aspect 28: The method of any of Aspects 26-27, wherein the one or more predicted channel characteristics are associated with one or more measurement resources associated with the CSI report, wherein the one or more measurement resources include at least one of a synchronization signal block, a CSI reference signal, or a demodulation reference signal.

Aspect 29: The method of Aspect 28, wherein the one or more predicted channel characteristics are associated with a same time domain occasion used for measurements associated with the one or more measurement resources, wherein the one or more prediction resources and the one or more measurement resources include non-overlapping transmission spatial filters.

Aspect 30: The method of Aspect 28, wherein the one or more predicted channel characteristics are associated with a time occasion that is later than a time occasion used for measurements associated with the one or more measurement resources or that is later than a time occasion used for receiving the CSI report.

Aspect 31: The method of Aspect 28, wherein the one or more prediction resources are associated with a frequency spectrum that is different than a frequency spectrum associated with the one or more measurement resources.

Aspect 32: The method of any of Aspects 26-31, wherein the CSI report is a first CSI report and the report quantity indicator is a first report quantity indicator, wherein a first priority order for the first CSI report is a same priority order as a second priority order for a second CSI report based at least in part on the second CSI report having a second report quantity indicator that indicates a measured L1 reference signal received power (RSRP) or L1 signal-to-interference-plus-noise ratio (SINR), wherein the first report quantity indicator that indicates the one or more predicted channel characteristics indicates at least one of a predicted L1 RSRP, a predicted L1 SINR, or a predicted top quantity of resources.

Aspect 33: The method of any of Aspects 26-32, wherein the CSI report is a first CSI report that includes a time domain beam prediction report associated with a single serving cell and the report quantity indicator is a first report quantity indicator, wherein a first priority order for the first CSI report is lower than a second priority order for a second CSI report based at least in part on the second CSI report including an L1 reference signal received power (RSRP) or L1 signal-to-interference-plus-noise ratio (SINR) or based at least in part on the second CSI report including a predicted L1 RSRP, L1 SINR, or top quantity of resources not associated with a future measurement occasion, and that is higher than a third priority order for a third CSI report that does not include a measured or predicted L1 RSRP or L1 SINR, wherein the first report quantity indicator that indicates the one or more predicted channel characteristics indicates at least one of a predicted L1 RSRP, a predicted L1 SINR, or a predicted top quantity of resources.

Aspect 34: The method of any of Aspects 26-33, further comprising transmitting information associated with determining the priority order for the CSI report, wherein the CSI report includes a time domain beam prediction report associated with a plurality of serving cells, and wherein the report quantity indicator that indicates the one or more predicted channel characteristics indicates at least one of a predicted L1 reference signal received power, a predicted L1 signal-to-interference-plus-noise ratio (SINR), or a predicted top quantity of resources.

Aspect 35: The method of Aspect 34, wherein the priority order for the CSI report is based at least in part on one or more prediction resources associated with one or more serving cells of the plurality of serving cells that are different from a serving cell of the plurality of serving cells that is an active serving cell for a user equipment transmitting the CSI report.

Aspect 36: The method of any of Aspects 26-35, further comprising transmitting information associated with determining the priority order for the CSI report, wherein the CSI report includes a beam prediction report for predicting a top quantity of resources, and wherein the report quantity indicator that indicates the one or more predicted channel characteristics indicates the top quantity of resources associated with an L1 reference signal received power or an L1 signal-to-interference-plus-noise ratio.

Aspect 37: The method of any of Aspects 26-36, further comprising transmitting information associated with determining the priority order for the CSI report, wherein the CSI report includes a frequency domain beam prediction report, and wherein the report quantity indicator that indicates the one or more predicted channel characteristics indicates at least one of a predicted L1 reference signal received power, a predicted L1 signal-to-interference-plus-noise ratio (SINR), or a predicted top quantity of resources.

Aspect 38: A method of wireless communication performed by a network node, comprising: transmitting a priority order for a plurality of channel state information (CSI) sub-groups included in a CSI report, the plurality of CSI sub-groups being multiplexed on a physical uplink control channel (PUCCH) or a physical uplink shared channel (PUSCH); and receiving one or more CSI sub-groups of the plurality of CSI sub-groups in accordance with the priority order, the CSI report including a report quantity indicator that indicates a plurality of predicted channel characteristics, the plurality of predicted channel characteristics being predicted by one or more prediction resources associated with the CSI report.

Aspect 39: The method of Aspect 38, wherein the one or more prediction resources are based at least in part on a synchronization signal block, a CSI reference signal, or a virtual resource, and wherein the plurality of predicted channel characteristics are based at least in part on a Layer 1 (L1) reference signal received power (RSRP), an L1 signal-to-interference-plus-noise ratio (SINR), a top quantity of resources associated with the L1 RSRP, or a top quantity of resources associated with the L1 SINR.

Aspect 40: The method of any of Aspects 38-39, wherein the plurality of predicted channel characteristics are based at least in part on one or more measurement resources associated with the CSI report, and wherein the one or more measurement resources include at least one of a synchronization signal block, a CSI reference signal, or a demodulation reference signal.

Aspect 41: The method of Aspect 40, wherein the plurality of predicted channel characteristics are predicted during a same time domain occasion used for measurements associated with the one or more measurement resources, wherein the one or more prediction resources and the one or more measurement resources include non-overlapping transmission spatial filters.

Aspect 42: The method of Aspect 40, wherein the plurality of predicted channel characteristics are predicted during a time occasion that is later than a time occasion for measurements associated with the one or more measurement resources or that is later than a time occasion used for transmitting the CSI report.

Aspect 43: The method of Aspect 40, wherein the one or more prediction resources are associated with a frequency spectrum that is different than a frequency spectrum associated with the one or more measurement resources.

Aspect 44: The method of any of Aspects 38-43, wherein the plurality of CSI sub-groups are associated with the plurality of predicted channel characteristics, and wherein each CSI sub-group of the plurality of CSI sub-groups corresponds to a respective future time domain occasion of a plurality of future time domain occasions.

Aspect 45: The method of Aspect 44, wherein a priority order for a CSI sub-group of the plurality of CSI sub-groups is determined based at least in part on a future time domain occasion that corresponds to the CSI sub-group and a time domain occasion that corresponds to a transmission of the CSI report.

Aspect 46: The method of Aspect 44, wherein a priority order for a CSI sub-group of the plurality of CSI sub-groups is determined based at least in part on a future time domain occasion that corresponds to the CSI sub-group and a time domain occasion that corresponds to a most recent time domain occasion during which one or more measurements are performed using one or more measurement resources associated with the CSI report.

Aspect 47: An apparatus for wireless communication at a device, comprising a processor; memory coupled with the processor; and instructions stored in the memory and executable by the processor to cause the apparatus to perform the method of one or more of Aspects 1-46.

Aspect 48: A device for wireless communication, comprising a memory and one or more processors coupled to the memory, the one or more processors configured to perform the method of one or more of Aspects 1-46.

Aspect 49: An apparatus for wireless communication, comprising at least one means for performing the method of one or more of Aspects 1-46.

Aspect 50: A non-transitory computer-readable medium storing code for wireless communication, the code comprising instructions executable by a processor to perform the method of one or more of Aspects 1-46.

Aspect 51: A non-transitory computer-readable medium storing a set of instructions for wireless communication, the set of instructions comprising one or more instructions that, when executed by one or more processors of a device, cause the device to perform the method of one or more of Aspects 1-46.

The foregoing disclosure provides illustration and description but is not intended to be exhaustive or to limit the aspects to the precise forms disclosed.

Modifications and variations may be made in light of the above disclosure or may be acquired from practice of the aspects.

As used herein, the term “component” is intended to be broadly construed as hardware, firmware, or a combination of hardware and software. As used herein, a processor is implemented in hardware, firmware, or a combination of hardware and software. As used herein, the phrase “based on” is intended to be broadly construed to mean “based at least in part on.” As used herein, “satisfying a threshold” may, depending on the context, refer to a value being greater than the threshold, greater than or equal to the threshold, less than the threshold, less than or equal to the threshold, equal to the threshold, or not equal to the threshold, among other examples. As used herein, a phrase referring to “at least one of” a list of items refers to any combination of those items, including single members. As an example, “at least one of: a, b, or c” is intended to cover: a, b, c, a +b, a +c, b +c, and a +b +c.

Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (for example, related items, unrelated items, or a combination of related and unrelated items), and may be used interchangeably with “one or more.” Where only one item is intended, the phrase “only one” or similar language is used.

Also, as used herein, the terms “has,” “have,” “having,” and similar terms are intended to be open-ended terms that do not limit an element that they modify (for example, an element “having” A also may have B). Further, as used herein, the term “or” is intended to be inclusive when used in a series and may be used interchangeably with “and/or,” unless explicitly stated otherwise (for example, if used in combination with “either” or “only one of”).

The various illustrative logics, logical blocks, modules, circuits and algorithm processes described in connection with the aspects disclosed herein may be implemented as electronic hardware, computer software, or combinations of both. The interchangeability of hardware and software has been described generally, in terms of functionality, and illustrated in the various illustrative components, blocks, modules, circuits and processes described herein. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single-or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Aspects of the subject matter described in this specification also can be implemented as one or more computer programs (such as one or more modules of computer program instructions) encoded on a computer storage media for execution by, or to control the operation of, a data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers.

Combinations of the media described herein should also be included within the scope of computer-readable media. Additionally, the operations of a method or algorithm may reside as one or any combination or set of codes and instructions on a machine readable medium and computer-readable medium, which may be incorporated into a computer program product.

Various modifications to the aspects described in this disclosure may be readily apparent to those skilled in the art, and the generic principles defined herein may be applied to other aspects without departing from the spirit or scope of this disclosure. Thus, the claims are not intended to be limited to the aspects shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate aspects also can be implemented in combination in a single aspect. Conversely, various features that are described in the context of a single aspect also can be implemented in multiple aspects separately or in any suitable subcombination. Moreover, although features may be described as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the aspects described should not be understood as requiring such separation in all aspects, and it should be understood that the described program components and systems can generally be integrated together in a single software product or packaged into multiple software products. Additionally, other aspects are within the scope of the following claims. In some cases, the actions recited in the claims can be performed in a different order and still achieve desirable results.

1. A user equipment (UE) for wireless communication, comprising:
one or more memories; and
one or more processors coupled to the one or more memories, the one or more processors individually or collectively configured to:
identify a priority order for transmitting a channel state information (CSI) report; and
selectively transmit the CSI report in accordance with the priority order, the CSI report including a report quantity indicator that indicates one or more predicted channel characteristics, the one or more predicted channel characteristics being predicted by one or more prediction resources associated with the CSI report.

2-7. (canceled)

8. The UE of claim 1, wherein the CSI report is a first CSI report and the report quantity indicator is a first report quantity indicator, wherein the one or more processors, to identify the priority order for the CSI report, are configured to identify a first priority order for the first CSI report that is a same priority order as a second priority order for a second CSI report based at least in part on the second CSI report having a second report quantity indicator that indicates a measured L1 reference signal received power (RSRP) or L1 signal-to-Attorney interference-plus-noise ratio (SINR), wherein the first report quantity indicator that indicates the one or more predicted channel characteristics indicates at least one of a predicted L1 RSRP, a predicted L1 SINR, or a predicted top quantity of resources.

9. The UE of claim 1, wherein the CSI report is a first CSI report that includes a time domain beam prediction report associated with a single serving cell and the report quantity indicator is a first report quantity indicator, wherein the one or more processors, to identify the priority order for the CSI report, are configured to identify a first priority order for the first CSI report that is lower than a second priority order for a second CSI report and is higher than a third priority order for a third CSI report that does not include a measured or predicted L1 RSRP or L1 SINR, wherein the one or more processors, to identify that the first priority order for the first CSI report is lower than the second priority order for the second CSI report, are configured to identify that the first priority order for the first CSI report is lower than the second priority order for the second CSI report based at least in part on the second CSI report including an L1 reference signal received power (RSRP) or L1 signal-to-interference-plus-noise ratio (SINR) or based at least in part on the second CSI report including a predicted L1 RSRP, a predicted L1 SINR, or a predicted top quantity of resources not associated with a future measurement occasion, and wherein the first report quantity indicator that indicates the one or more predicted channel characteristics indicates at least one of a predicted L1 RSRP, a predicted L1 SINR, or a predicted top quantity of resources.

10. The UE of claim 9, wherein the one or more processors are further configured to identify at least one of the first priority order, the second priority order, or the third priority order based at least in part on whether the first CSI report, the second CSI report, or the third CSI report is associated with a periodic transmission, a semi-persistent transmission, an aperiodic transmission, a physical uplink shared channel transmission, or a physical uplink control channel transmission.

11. The UE of claim 1, wherein the CSI report includes a time domain beam prediction report associated with a plurality of serving cells, wherein the one or more processors, to identify the priority order for the CSI report, are configured to identify the priority order for the CSI report in accordance with an indication received from a network node, wherein the report quantity indicator that indicates the one or more predicted channel characteristics indicates at least one of a predicted L1 reference signal received power, a predicted L1 signal-to-interference-plus-noise ratio, or a predicted top quantity of resources.

12. (canceled)

13. The UE of claim 1, wherein the CSI report includes a beam prediction report for predicting a top quantity of resources, wherein the one or more processors, to identify the priority order for the CSI report, are configured to identify the priority order for the CSI report in accordance with an indication received from a network node, wherein the report quantity indicator that indicates the one or more predicted channel characteristics indicates the top quantity of resources associated with an L1 reference signal received power or an L1 signal-to-interference-plus-noise ratio.

14. The UE of claim 1, wherein the CSI report includes a frequency domain beam prediction report, wherein the one or more processors, to identify the priority order for the CSI report, are configured to identify the priority order for the CSI report in accordance with an indication received from a network node, wherein the report quantity indicator that indicates the one or more predicted channel characteristics indicates at least one of a predicted L1 reference signal received power, a predicted L1 signal-to-interference-plus-noise ratio, or a predicted top quantity of resources.

15. (canceled)

16. A user equipment (UE) for wireless communication, comprising:
one or more memories; and
one or more processors coupled to the one or more memories, the one or more processors individually or collectively configured to:
identify a priority order for transmitting a plurality of channel state information (CSI) sub-groups via a CSI report, the plurality of CSI sub-groups being multiplexed on a physical uplink control channel (PUCCH) or a physical uplink shared channel (PUSCH); and
selectively transmit one or more CSI sub-groups of the plurality of CSI sub-groups in accordance with the priority order, the CSI report including a report quantity indicator that indicates a plurality of predicted channel characteristics, the plurality of predicted channel characteristics being predicted by one or more prediction resources associated with the CSI report.

17. The UE of claim 16, wherein the one or more processors, to selectively transmit the one or more CSI sub-groups in accordance with the priority order, are configured to refrain from transmitting a CSI sub-group having a lower priority order prior to refraining from transmitting another CSI sub-group having a higher priority order.

18. The UE of claim 16, wherein the one or more processors are further configured to determine to transmit the one or more CSI sub-groups at a feedback occasion or to refrain from transmitting the one or more CSI sub-groups at a feedback occasion in accordance with the priority order, wherein the one or more prediction resources are based at least in part on a synchronization signal block, a CSI reference signal, or a virtual resource, and wherein the plurality of predicted channel characteristics are based at least in part on a Layer 1 (L1) reference signal received power (RSRP), an L1 signal-to-interference-plus-noise ratio (SINR), a top quantity of resources associated with the L1 RSRP, or a top quantity of resources associated with the L1 SINR.

19. The UE of claim 16, wherein the one or more processors are further configured to identify the plurality of predicted channel characteristics based at least in part on one or more measurement resources associated with the CSI report, wherein the one or more measurement resources include at least one of a synchronization signal block, a CSI reference signal, or a demodulation reference signal.

20. The UE of claim 19, wherein the plurality of predicted channel characteristics are predicted during a same time domain occasion used for performing measurements associated with the one or more measurement resources, wherein the one or more prediction resources and the one or more measurement resources include non-overlapping transmission spatial filters.

21. The UE of claim 19, wherein the plurality of predicted channel characteristics are predicted during a time occasion that is later than a time occasion used for performing measurements associated with the one or more measurement resources or that is later than a time occasion used for transmitting the CSI report.

22. The UE of claim 19, wherein the one or more prediction resources are associated with a frequency spectrum that is different than a frequency spectrum associated with the one or more measurement resources.

23. The UE of claim 16, wherein the plurality of CSI sub-groups are associated with the plurality of predicted channel characteristics, and wherein each CSI sub-group of the plurality of CSI sub-groups corresponds to a respective future time domain occasion of a plurality of future time domain occasions.

24. The UE of claim 23, wherein the one or more processors are further configured to determine a priority order for a CSI sub-group of the plurality of CSI sub-groups based at least in part on a future time domain occasion that corresponds to the CSI sub-group and a time domain occasion that corresponds to a transmission of the CSI report.

25. The UE of claim 23, wherein the one or more processors are further configured to determine a priority order for a CSI sub-group of the plurality of CSI sub-groups based at least in part on a future time domain occasion that corresponds to the CSI sub-group and a time domain occasion that corresponds to a most recent time domain occasion during which one or more measurements are performed using one or more measurement resources associated with the CSI report.

26. A network node for wireless communication, comprising:
one or more memories; and
one or more processors coupled to the one or more memories, the one or more processors individually or collectively configured to:
transmit an indication of a priority order for channel state information (CSI) reporting; and
receive a CSI report in accordance with the priority order, the CSI report including a report quantity indicator that indicates one or more predicted channel characteristics, the one or more predicted channel characteristics being predicted by one or more prediction resources associated with the CSI report.

27. The network node of claim 26, wherein the one or more prediction resources are associated with a synchronization signal block, a CSI reference signal, or a virtual resource, and wherein the one or more predicted channel characteristics are based at least in part on a Layer 1 (L1) reference signal received power (RSRP), an L1 signal-to-interference-plus-noise ratio (SINR), a top quantity of resources associated with the L1 RSRP, or a top quantity of resources associated with the L1 SINR.

28. The network node of claim 26, wherein the one or more predicted channel characteristics are associated with one or more measurement resources associated with the CSI report, wherein the one or more measurement resources include at least one of a synchronization signal block, a CSI reference signal, or a demodulation reference signal.

29-30. (canceled)
